(19) United States
(12) Patent Application Publication
(10) Pub. No.: US 2025/0388063 A1
(43) Pub. Date: Dec. 25, 2025

(54) VENT ASSEMBLY AND HVAC SYSTEM FOR A VEHICLE CABIN

(71) Applicant: JAGUAR LAND ROVER LIMITED, Whitley, Coventry, Warwickshire (GB)

(72) Inventors: Phil HARRISON, Whitley, Coventry, Warwickshire (GB); Richard JOHNSON, Whitley, Coventry, Warwickshire (GB); Dawid BUGAJ, Whitley, Coventry, Warwickshire (GB); Yannick JOSSE, Whitley, Coventry, Warwickshire (GB); John HALL, Whitley, Coventry, Warwickshire (GB); Akshay SHIRSIKAR, Whitley, Coventry, Warwickshire (GB); Hongjun CHEN, Whitley, Coventry, Warwickshire (GB); Lin LI, Whitley, Coventry, Warwickshire (GB); Lifeng HUANG, Whitley, Coventry, Warwickshire (GB); Shize CEN, Whitley, Coventry, Warwickshire (GB); Jianqing ZHANG, Whitley, Coventry, Warwickshire (GB); Qiangyin ZHANG, Whitley, Coventry, Warwickshire (GB); Zhenping LI, Whitley, Coventry, Warwickshire (GB)

(21) Appl. No.: 18/877,838

(22) PCT Filed: Jun. 21, 2023
(86) PCT No.: PCT/EP2023/066827

§ 371 Date: Dec. 20, 2024

(30) Foreign Application Priority Data
Jun. 21, 2022 (CN) 202210704037.7
Jun. 21, 2022 (CN) 202221565143.3
Jun. 30, 2022 (CN) 202210756449.5
Jan. 5, 2023 (GB) 2300160.5

(51) Int. Cl. B60H 1/34

(52) U.S. Cl. CPC B60H 1/345; B60H 2001/3471

(57) ABSTRACT

A vent assembly for a vehicle cabin comprises a first set of vanes and a second set of vanes, each for directing air into the vehicle cabin, a first cam path and a second cam path defined by one or more cams, the one or more cams being mounted to a common rotatable shaft, and a first cam follower operably coupled between the first cam path and the first set of vanes, and a second cam follower operably coupled between the second cam path and the second set of vanes. Rotation of the common shaft causes the one or more cams to rotate, and the cam followers to follow the respective cam paths, to adjust the relative angle of the first and second sets of vanes. In this way, two different sets of vanes can be controlled differently using rotation of a single shaft.

### CROSS REFERENCE TO RELATED APPLICATIONS

The present application is a U.S. National Phase of International Application No. PCT/EP2023/066827 entitled “VENT ASSEMBLY AND HVAC SYSTEM FOR A VEHICLE CABIN,” and filed on Jun. 21, 2023. International Application No. PCT/EP2023/066827 claims priority to Chinese Patent Application No. 202221565143.3 filed on Jun. 21, 2022, Chinese Patent Application No. 202210704037.7 filed on Jun. 21, 2022, Chinese Patent Application No. 202210756449.5 filed on Jun. 30, 2022, and to Great Britain Patent Application No. 2300160.5 filed on Jan. 5, 2023. The entire contents of each of the above-listed applications are hereby incorporated by reference for all purposes.

### TECHNICAL FIELD

The present disclosure relates to a vent assembly. Embodiments of the present disclosure further relate to an HVAC system for a vehicle cabin, a method and computer software for controlling a vent assembly, and to a vehicle with such a system or incorporating such a vent assembly.

### BACKGROUND

Modern vehicles are commonly provided with an HVAC (Heating, Ventilation and Air Conditioning) system for their vehicle cabin. The HVAC is able to control the temperature within the vehicle cabin (that is, to heat it, or cool it), and to direct streams or jets of heated or cooled air into or onto desired regions and/or surfaces within the vehicle cabin, such as the windscreen (to provide a demisting function) or onto the face, body or feet of an individual sat in the vehicle cabin, or just generally into the cabin volume to promote air movement and vary/maintain cabin temperature. For example, air may be directed into the front footwells, into the central area of the cabin, or onto the upper body or face of the driver. Air is usually directed into the cabin through vents provided in cabin structures.

Face level vents may be provided, generally in the instrument panel, to deliver the most noticeable airflow for the user (driver or front passenger(s)). Usually these vents are equipped with functions to enable the user to adjust the direction of airflow (onto or away from their face for example), and to throttle the output of the vents to their preference. Traditional air vents have vertical vanes for controlling left and right direction of airflow, and horizontal vanes for upwards and downwards direction control. The vertical vanes are commonly operated manually by a user, and allow the complete airflow from the vent to be directed centrally of the vent, to the left, or the right.

While traditional face vents are provided to either side of the driver, and to either side of the passenger, the present disclosure envisages the placement of face vents directly in front of the driver (behind the steering wheel), and directly in front of the front row passenger. With the air vent directly in front of the user, more options for lateral airflow control are required to both target and avoid specific areas.

### SUMMARY OF THE INVENTION

Aspects and embodiments of the invention provide a vent assembly, an HVAC system for a vehicle cabin, a method and computer software, and to a vehicle having a cabin provided with such an HVAC system and one or more such vent assemblies. The vehicle cabin is preferably a cabin of an automobile, but may instead be for a lorry or other commercial vehicle, a maritime vessel or an aircraft.

According to an aspect of the present invention there is provided a vent assembly for a vehicle cabin, comprising:
a first set of vanes and a second set of vanes, each for directing air into the vehicle cabin;
a first cam path and a second cam path defined by one or more cams, the one or more cams being mounted to a common rotatable shaft;
a first cam follower operably coupled between the first cam path and the first set of vanes,
and a second cam follower operably coupled between the second cam path and the second set of vanes;
wherein rotation of the common shaft causes the one or more cams to rotate, and the first and second cam followers to follow the respective first and second cam paths, to adjust a relative angle of the first and second sets of vanes.

The first cam path and second cam path may each be defined on a respective cam wheel, the cam wheels both being mounted to the shaft. In an alternative implementation, the first and second cam paths may be defined on the same cam wheel. For example, cam wheel may have first and second faces on opposite sides of the cam wheel, wherein the first cam path may be defined on the first face of the cam wheel, while the second cam path may be defined on the second face of the same cam wheel. It will be understood in this case that the cam followers will engage with opposite faces of the same cam wheel. Alternatively, the first and second cam paths may be defined on the same side of a single cam wheel, for example as inner and outer paths.

In any of these cases, the cam paths may be tracks defined on one or more planar surfaces of the cam wheels. The planar surfaces may be perpendicular to the rotation axis of the common shaft. In this case, the first cam follower and the second cam follower may each comprise a pin for engagement in the first and second track respectively.

In the case of two cam wheels, the first and second cam paths may be disposed facing each other. That is, the first cam path may be defined on the side of a first cam wheel facing the second cam wheel, while the second cam path may be defined on the side of the second cam wheel facing the first cam wheel. In this case, at least part of the first cam follower and the second cam follower may be in slideable contact with each other between the cam wheels bearing the first and second cam paths. Preferably, the first and second cam followers are held against each other between the cam wheels to retain the respective pins in the tracks. In this way, the cam wheels and followers have a compact and self-supporting structure, and the pins are retained securely in the tracks at all times without the need for additional securing elements.

The cam followers may extend beyond the cam wheels and be restrained from movement except in one action-direction parallel to the planar surfaces of the cam wheels, whereby rotation of the common shaft moves the cam followers in said action-direction as the cam path changes its position with respect to said action direction as the cam path approaches towards and away from the rotation axis of the common shaft. The action-direction may be radial with respect to the axis of the common shaft. The position of each cam follower in said action-direction therefore depends on the rotational position of the common shaft and the shape of the respective cam path.

The cam followers may be coupled to the sets of vanes so as to pivot each vane in the set about a respective vane axis as the cam follower moves in said action-direction. The vane axis of each vane in a vane set may be parallel each other. The relative position of the cam followers in said action-direction determines a respective vane configuration.

Rotation of the common shaft, and thus following of the cam followers in their first and second cam paths, permits the respective angle of the first and second sets of vanes to be adjusted differently. Since portions of (but not all of) the two cam paths may be coincident, the first and second sets of vanes move together (with no change in their relative angle) for portions of the common shaft rotation, but move differently (with a change in their relative angle) for other portions of the common shaft rotation.

In this way, two different sets of vanes can be controlled differently (but not independently) using rotation of a single shaft.

Each of the cam paths may define a continuous loop. In this way a desired vane configuration as between the two vane sets may be achieved by a rotation of the common shaft, and the required degree of common shaft rotation may be minimised by selecting the direction of rotation of the common shaft.

While the present technique could be implemented manually, by way of the common shaft being rotated, directly or indirectly, by manual manipulation by a user (for example by turning a dial), preferably a motor is provided for rotating the shaft.

An (electronic) controller may be provided, for controlling the position of the first and second sets of vanes by adjusting the rotational position of the common shaft. The controller may be configured to select a direction of rotation of the shaft in dependence on which direction would reach a desired configuration for the first and second sets of vanes with the least shaft rotation.

While the present technique could be used for horizontal or diagonal vanes, the vanes of both sets may be substantially vertical. In relation particularly to face vents, this helps achieve desired airflow configurations to target or avoid the driver and/or passenger.

The vent assembly that is controlled by the first and second set of vanes may have the first and second set of vanes arranged adjacent one another whereby, if the vanes of the first and second sets are aligned in the same direction, a single, broad air flow path exits the vent assembly, whereas, if they are oriented differently to one another, two flow paths in different directions exit the vent assembly, either in diverging directions where they remain separate, or in converging directions, where they mix to form a single focused air flow. The rotation axes of the vanes of each set may be parallel.

In a vent assembly in accordance with the invention where the first and second set of vanes are disposed side by side with the first set of vanes being disposed to the right of the second set of vanes, for example in a substantially horizontal direction across a vehicle dashboard in front of a driver or passenger, the first and second cam paths may be defined such that the first set of vanes and the second set of vanes can be configured in each of:
a first, neutral, configuration, in which both sets of vanes are aligned in the same, forward, direction,
a second configuration in which both sets of vanes are aligned in the same, leftward, direction,
a third configuration in which both sets of vanes are aligned in the same, rightward, direction,
a fourth configuration in which the first set of vanes is aligned in a leftward direction and the second set of vanes is aligned in a rightward direction so as to converge and concentrate the airflow exiting the vent assembly, and
a fifth configuration in which the first set of vanes is aligned in a rightward direction and the second set of vanes are aligned in a leftward direction to diverge the airflow into separate streams.

In some implementations, with a complete rotation of the common shaft the first, neutral, configuration is arranged to arise twice. From a first one of the first, neutral, configurations, rotation of the common shaft in a first direction may move the vanes into the second configuration and rotation of the common shaft in a second direction may move the vanes into the third configuration. From a second one of the first, neutral, configurations, rotation of the common shaft in one direction may move the vanes into the fourth configuration and rotation of the common shaft in an opposite direction may move the vanes into the fifth configuration.

The presence of two neutral positions, in each case surrounded by a pair of other (related) configurations presents a natural feeling transition for the user—that is, it is not always necessary to transition through multiple unwanted modes before reaching a desired mode.

The foregoing arrangement is provided by the shape of the cam paths around the axis of the common shaft. The first path may have rotational symmetry of order 2 about its axis of rotation (and having two axes of mirror symmetry), and the second path may have no rotational symmetry (and having one axis of mirror symmetry). The first cam path may comprise two lobes of substantially equal size at opposite sides of the rotational axis of the common shaft and defining four first path positions comprising two first path minimal positions close to the axis of rotation and offset with respect to each other by 180 degrees and two first path maximal positions remote from the shaft and offset with respect to each other by 180 degrees and offset from the minimal positions by approximately 90 degrees. The second path may comprise a larger lobe on one side of the shaft and extending over a maximal range remote from the shaft at rotational positions corresponding with an approximately 90 degree rotation of the common shaft between first maximal and minimal positions of the first cam path, and a smaller lobe on the other side of the shaft and extending over a minimal range close to the shaft at rotational positions corresponding with an approximately 90 degree rotation of the common shaft between second maximal and minimal positions of the first cam path.

Thus, rotation of the common shaft over 360 degrees of rotation provides four extreme positions, in which:
1. the first maximal position of the first cam path coincides with the minimal range of the second cam path;
2. the first minimal position of the first cam path remains coinciding with the minimal range of the second cam path;
3. the second maximal position of the first cam path coincides with the maximal range of the second cam path; and
4. the second minimal position of the first cam path remains coinciding with the maximal range of the second cam path.

Intermediate positions also exist between the four extreme positions and these provide two occasions of the first, neutral configuration (positions 5, 6 in Table 1 below) and two occasions (positions 7, 8 in Table 1) where the first set of vanes are in the neutral position while the second set of vanes is in either the maximal (for example, leftwardly directed) or minimal positions (that is, rightwardly directed).

TABLE 1

| Position | Rotation | Cam | Cam | Vents | Vents | Vent | | FIG. 5 |
|---|---|---|---|---|---|---|---|---|
| No. | Angle | Path 1 | Path 2 | L | R | Airflow | Configuration | ref. |
| 5 | 360/0 | Mid | Mid | N | N | Forward | First(2) | A |
| 3 | 315 | Max | Max | R | R | Right | Third | B |
| 7 | 270 | Mid | Max | N | R | R/neutral | Undefined | |
| 4 | 225 | Min | Max | L | R | Divergent | Fourth | C |
| 6 | 180 | Mid | Mid | N | N | Forward | First(1) | D |
| 1 | 135 | Max | Min | R | L | Focussed | Fifth | E |
| 8 | 90 | Mid | Min | N | L | L/neutral | Undefined | |
| 2 | 45 | Min | Min | L | L | Left | Second | F |

Table 1 identifies the possible arrangements of the cam paths and resultant vent configurations. With reference to the Cam Path 1,2 entries, Max refers to a maximal distance from the common shaft axis, Min refers to a minimal distance from the common shaft axis and Mid refers to an intermediate position. From this it can be seen that the axes of mirror symmetry of the first and second cam paths are offset with respect to one another by approximately 45 degrees.

From Table 1, it is evident that, as the common shaft rotates through 360 degrees, the cam paths arrange for the vane assembly to proceed through the configurations described above. It is also evident that to change from one configuration to another, the direction of rotation of the common shaft affects the number of configurations through which the vent assembly passes before the new configuration is reached. The first, neutral configuration exists in two different common shaft rotation positions, but which configuration is adjacent to it depends in which of the two positions (positions 5 or 6 in Table 1, 180 degrees apart) the shaft is oriented. A controller may be provided to determine the direction of rotation required to reach a desired configuration of the vent assembly from a current configuration via the smallest number of undesired configurations.

Thus, according to an aspect of the invention, there is provided a method of controlling a vent assembly as defined above, the method comprising:
determining a current vane configuration of the first and second set of vanes,
selecting a desired vane configuration,
determining the smaller angle of rotation of the shaft required to configure the first and second set of vanes in the desired configuration; and
controlling rotation of the shaft through said smaller angle.

Computer software may be provided that, when executed, is arranged to perform the method defined above.

It is to be noted that the two undefined configurations (positions 7, 8 in Table 1) result in flows from the vent assembly that are unlikely to ever be employed, in practice. In these positions of the common shaft, one set of vanes are facing forward and the other is either diverging from it or converging with it.

According to an aspect of the invention, there is provided a vehicle comprising a vent assembly as described above, the vehicle comprising a vent outlet into the vehicle cabin, and wherein the vent outlet is disposed directly in front of a front seat of the vehicle. The vent outlet may be disposed directly behind a steering wheel of the vehicle. The first and second sets of vanes may be configurable in a focused mode in which the first set of vanes and the second set of vanes are angled towards each other, and the air is converged into a stream to pass through the steering wheel and towards the driver.

According to another aspect, there is provided a vent assembly for a vehicle cabin, comprising:
a first set of vanes and a second set of vanes, each for directing air into the vehicle cabin through a vent outlet;
a controller for adjusting the angles of the first and second sets of vanes, the first and second sets of vanes being adjustable to the same or different angles;
wherein the controller is operable to adjust the respective angles of the first and second sets of vanes to turn towards each other to form a converged airflow.

According to an aspect of the invention, there is provided a vehicle comprising the vent assembly described in the preceding paragraph, wherein the vent outlet is disposed behind a steering wheel of the vehicle, and wherein the converged airflow is expelled from the vent outlet and through the steering wheel towards the driver of the vehicle.

Advantageously, such a configuration is able to target through the steering wheel and between the driver's hands and arms to reach their face.

According to another aspect of the invention, there is provided an HVAC system for a vehicle cabin, comprising the vent assembly described above.

According to another aspect of the invention, there is provided a vehicle comprising the vent assembly or the HVAC system according to the above.

In view of the disadvantages and defects of the prior art, provided is an air output device for an automobile air conditioner, which enables two sets of airflow guide blades to be driven to move, achieves the functions of concentrated air blowing, diffused air blowing, and air blowing in the same direction, has a simple structure and a small occupied space, and reduces the impact on air output regions.

In order to achieve the above objective, the present invention provides the following technical solutions:

Provided is an air output device for an automobile air conditioner, comprising a rotation assembly, a drive assembly, and a first blade set and a second blade set provided in an air output region, the first blade set comprising at least one first airflow guide blade oscillating from side to side in an X direction, and the second blade set comprising at least one second airflow guide blade oscillating from side to side in the X direction, wherein the rotation assembly comprises at least one rotation disk located away from the air output region, an end surface of the rotation disk is peripherally provided with a first cam slot and a second cam slot respectively, the drive assembly comprises a first drive rod and a second drive rod enabling the first blade set and the second blade set to oscillate in response to directional drive of the first cam slot and the second cam slot, the respective ends of the first drive rod and the second drive rod are slidably engaged with the first cam slot and the second cam slot respectively, and the respective other ends of the first drive rod and the second drive rod extend in the X direction towards the air output region, and are connected to the first blade set and the second blade set respectively.

The present invention has the following beneficial effects: In the air output device of the present invention, the first cam slot and the second cam slot are provided. During use, the rotation assembly rotates, the first cam slot and the second cam slot cause the first drive rod and the second drive rod to perform directional movement, so as to directionally drive the first airflow guide blade and the second airflow guide blade to oscillate. When the first airflow guide blade and the second airflow guide blade oscillate, the first airflow guide blade and the second airflow guide blade can oscillate outwards in opposite directions so as to achieve diffused air output, and can oscillate inwards in opposite directions so as to achieve concentrated air output, and can oscillate in the same direction so as to adjust an air output angle. The two sets of airflow guide blades can be adjusted by using one rotation assembly, thereby achieving a simple structure and easy adjustment, reducing the number of parts, costs and the overall size, and allowing the air output device to be easily arranged in an automobile. In addition, the rotation disk is configured to be located away from the air output region, so that air output is not affected. In addition, the respective other ends of the first drive rod and the second drive rod both extend in the X direction towards the air output region, so that the air output region is less affected, thereby ensuring the final air output performance.

As an improvement on the present invention, the rotation assembly comprises a first rotation disk having the first cam slot and a second rotation disk having the second cam slot, the first rotation disk and the second rotation disk are fixedly connected to each other by means of a connecting member, and the first cam slot and the second cam slot are respectively provided between surfaces of the first rotation disk and the second rotation disk facing each other.

As an improvement on the present invention, the first drive rod and the second drive rod are adjacent to each other, one of the first drive rod and the second drive rod being provided with a guide slot along a straight line, the other being provided with a guide block extending into the guide slot, and engagement between the guide block and the guide slot enabling the first drive rod and the second drive rod to guide each other.

As an improvement on the present invention, a plurality of first airflow guide blades are provided, and the first blade set further comprises a first connecting rod for linking the plurality of first airflow guide blades, a plurality of second airflow guide blades are provided, and the second blade set further comprises a second connecting rod for linking the plurality of second airflow guide blades, one end of the first drive rod is provided with a first drive block engaging with the first cam slot, the other end of the first drive rod is drivingly connected to one of the first airflow guide blades, and the first drive rod is parallel with the first connecting rod, and one end of the second drive rod is provided with a second drive block engaging with the second cam slot, the other end of the second drive rod is drivingly connected to one of the second airflow guide blades, and the second drive rod is parallel with the second connecting rod. By means of the above improvement, the impact on air output is reduced.

As an improvement on the present invention, the first cam slot has, in sequence, a first concentrated air output point, a first rightward air output point, a first leftward air output point, and a first diffused air output point, and the second cam slot has, in sequence, a second concentrated air output point, a second rightward air output point, a second leftward air output point, and a second diffused air output point, wherein the rotation assembly, when rotating, drives the first drive block to sequentially pass through the first concentrated air output point, the first rightward air output point, the first leftward air output point, and the first diffused air output point, while driving the second drive block to sequentially pass through the second concentrated air output point, the second rightward air output point, the second leftward air output point, and the second diffused air output point, so that directional movement of the first drive rod and the second drive rod directionally drives the first airflow guide blades and the second airflow guide blades to oscillate. The second drive block is at the second concentrated air output point when the first drive block is at the first concentrated air output point, the second drive block is at the second rightward air output point when the first drive block is at the first rightward air output point, the second drive block is at the second leftward air output point when the first drive block is at the first leftward air output point, and the second drive block is at the second diffused air output point when the first drive block is at the first diffused air output point.

As an improvement on the present invention, when the first drive block is at the first concentrated air output point, the second drive block is at the second concentrated air output point, and in this case, the first drive rod drives the first airflow guide blades to tilt towards the second airflow guide blades, and the second drive rod drives the second airflow guide blades to tilt towards the first airflow guide blades; when the first drive block is at the first rightward air output point, the second drive block is at the second rightward air output point, and in this case, the first drive rod drives the first airflow guide blades to tilt to the right in a first direction, and the second drive rod drives the second airflow guide blades to tilt to the right in the first direction; when the first drive block is at the first leftward air output point, the second drive block is at the second leftward air output point, and in this case, the first drive rod drives the first airflow guide blades to tilt to the left in the first direction, and the second drive rod drives the second airflow guide blades to tilt to the left in the first direction; when the first drive block is at the first diffused air output point, the second drive block is at the second diffused air output point, and in this case, the first drive rod drives the first airflow guide blades to tilt away from the second airflow guide blades, and the second drive rod drives the second airflow guide blades to tilt towards a position diffusing the first airflow guide blades.

As an improvement on the present invention, the rotation disk moves by rotating, the first cam slot is ring-shaped as a whole, the first concentrated air output point, the first rightward air output point, the first leftward air output point, and the first diffused air output point are annularly arranged, the second cam slot is ring-shaped as a whole, and the second concentrated air output point, the second rightward air output point, the second leftward air output point, and the second diffused air output point are annularly arranged.

As an improvement on the present invention, the first cam slot is provided with a first track segment between the first concentrated air output point and the first rightward air output point, is provided with a second track segment between the first rightward air output point and the first leftward air output point, is provided with a third track segment between the first leftward air output point and the first diffused air output point, and is provided with a fourth track segment between the first diffused air output point and the first concentrated air output point, and the second cam slot is provided with a first travel segment between the second concentrated air output point and the second rightward air output point, is provided with a second travel segment between the second rightward air output point and the second leftward air output point, is provided with a third travel segment between the second leftward air output point and the second diffused air output point, and is provided with a fourth travel segment between the second diffused air output point and the second concentrated air output point. During rotation of the rotation assembly, the first track segment, the second track segment, the third track segment, and the fourth track segment sequentially engage with the first drive block so as to restrict movement of the first drive block, and the first travel segment, the second travel segment, the third travel segment, and the fourth travel segment engage with the second drive block so as to restrict movement of the second drive block.

As an improvement on the present invention, distances from the first concentrated air output point, the first rightward air output point, the first leftward air output point, and the first diffused air output point to the center of rotation of the rotation assembly are respectively L1, L2, L3, and L4, where L2=L4>L1=L3; distances from the second concentrated air output point, the second rightward air output point, the second leftward air output point, and the second diffused air output point to the center of rotation of the rotation assembly are respectively S11.1, S11.2, S11.3, and S11.4, where S11.1=S11.2>S11.3=S11.4.

As an improvement on the present invention, the air output device further comprises an electric actuator, wherein the actuator is drivingly connected to the rotation assembly so as to drive the rotation assembly to perform circular rotation.

The technical problem to be solved by the present invention is to provide an air outlet blade adjustment mechanism, an electric air outlet, and a vehicle, so that two blade sets can be simultaneously controlled, by means of one power device, to rotate, and the two blade sets are allowed to be at different air blowing angles.

In order to solve the above technical problem, provided in the present invention is an air outlet blade adjustment mechanism, comprising:
a first blade set, comprising a plurality of airflow guide blades arranged at intervals in a first direction and rotatably provided in an air outlet;
a second blade set, comprising a plurality of airflow guide blades arranged at intervals in the first direction and rotatably provided in the air outlet;
a first shift fork, configured to move only in the first direction, connected to one of the airflow guide blades in the first blade set, and used to move to drive the airflow guide blades in the first blade set to rotate;
a second shift fork, configured to move only in the first direction, connected to one of the airflow guide blades in the second blade set, and used to move to drive the airflow guide blades in the second blade set to rotate;
a first drive member, connected to the first shift fork, and used to rotate to drive the first shift fork to be displaced in the first direction;
a second drive member, connected to the second shift fork, and used to rotate to drive the second shift fork to be displaced in the first direction; and
a power device, comprising a drive shaft, and used to drive, by means of the drive shaft, the first drive member and the second drive member to rotate synchronously, a rotation angle of the drive shaft comprising a plurality of consecutive rotation angle intervals, and displacement amounts and/or displacement directions of the first shift fork and the second shift fork being different in at least one of the rotation angle intervals.

Preferably, the first drive member is provided with a first mounting surface parallel with the first direction, the first mounting surface being provided with a first track slot portion, and the first shift fork being provided with a first connecting portion movable in the first track slot portion, wherein when the first drive member rotates, a side wall of the first track slot portion pushes the first connecting portion so that the first shift fork moves in the first direction; the second drive member is provided with a second mounting surface parallel with the first mounting surface, the second mounting surface being provided with a second track slot portion, and the second shift fork being provided with a second connecting portion movable in the second track slot portion, wherein when the second drive member rotates, a side wall of the second track slot portion pushes the second connecting portion so that the second shift fork moves in the first direction;
extension tracks of the first track slot portion and the second track slot portion are different.

Preferably, transit axes of the first drive member and the second drive member coincide with the axis of the drive shaft of the power device.

Preferably, a first position-limiting portion is fixed on the first drive member, and a second position-limiting portion is fixed on the second drive member, the first position-limiting portion and the second position-limiting portion being sleeved on each other, and position-limited circumferentially. Preferably, a bump is fixed on the first shift fork, and is provided with a chute extending in the first direction, and a slider having a shape matching a shape of the chute is fixed on the second shift fork, and is slidable in the chute.

Preferably, the first shift fork is provided with a first notch, and one of the airflow guide blades in the first blade set has a drive rod portion extending into the first notch, wherein when the first shift fork drives, by means of the drive rod portion and the first notch, the airflow guide blade to rotate, the drive rod portion slides relatively in the first notch in the depth direction of the first notch;
the second shift fork is provided with a second notch, and one of the airflow guide blades in the second blade set has a drive rod portion extending into the second notch, wherein when the second shift fork drives, by means of the drive rod portion and the second notch, the airflow guide blade to rotate, the drive rod portion slides relatively in the second notch in the depth direction of the second notch.

Preferably, all of the airflow guide blades in the first blade set are transmissively connected by means of a first connecting rod so as to rotate synchronously, and all of the airflow guide blades in the second blade set are transmissively connected by means of a second connecting rod so as to rotate synchronously.

Provided in the present invention is an electric air outlet assembly, comprising the air outlet blade adjustment mechanism.

Provided in the present invention is a vehicle, comprising the electric air outlet assembly.

By adopting the above structure, the present invention has the following advantages as compared to the prior art:

When the air outlet blade adjustment mechanism of the present invention operates, the power device drives the first drive member and the second drive member to rotate synchronously. The rotating first drive member drives the first shift fork to move in the first direction. The rotating second drive member drives the second shift fork to move in the first direction. When the first drive member and the second drive member rotate, displacement amounts and/or displacement directions of the first shift fork and the second shift fork are different, so that rotation angles of the airflow guide blades in the first blade set and the airflow guide blades the second blade set are different. Therefore, the first blade set and the second blade set can be driven by one power device to act so as to be at different air blowing angles.

Within the scope of this disclosure it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle in which the invention may be used;

FIG. 2 shows a high-level block diagram of the vent assembly and control function; FIGS. 3A and 3B show structural elements of the vent assembly referenced in FIG. 2;

FIG. 4 shows the airflow configurations achievable using the vent assembly;

FIG. 5 shows the sequence of airflow configurations as a function of rotational position of the shaft;

FIG. 6 is a schematic flow diagram of a control method;

FIG. 7 is a schematic diagram of the overall structure of the present invention;

FIG. 8 is a schematic structural diagram illustrating engagement between a first rotation disk and a first drive rod according to the present invention;

FIG. 9 is a schematic structural diagram of a first drive rod according to the present invention;

FIG. 10 is a schematic structural diagram illustrating engagement between a second rotation disk and a second drive rod according to the present invention;

FIG. 11 is a schematic structural diagram of a second drive rod according to the present invention;

FIG. 12 is a schematic structural diagram of a first rotation disk according to the present invention;

FIG. 13 is a schematic structural diagram of a second rotation disk according to the present invention;

FIG. 14 is a schematic structural diagram of a concentrated air output state according to the present invention;

FIG. 15 is a schematic structural diagram of a rightward air output state according to the present invention;

FIG. 16 is a schematic structural diagram of a leftward air output state according to the present invention;

FIG. 17 is a schematic structural diagram of a diffused air output state according to the present invention;

FIG. 18 is a schematic structural diagram of an embodiment of the present invention;

FIG. 19 is a schematic structural diagram of a first shift fork;

FIG. 20 is a schematic structural diagram of a second shift fork;

FIG. 21 is a schematic structural diagram of an airflow guide blade;

FIG. 22 is a schematic structural diagram of a first drive member; and

FIG. 23 is a schematic structural diagram of a second drive member.

In the drawings: 11.1, first blade set; 1.1, first airflow guide blade; 1.2, first connecting rod; 11.2, second blade set; 2.1, second airflow guide blade, 2.2, second connecting rod; 11.3, first rotation disk; 3.1, first cam slot; 3.11, first concentrated air output point; 3.12, first rightward air output point; 3.13, first leftward air output point, 3.14, first diffused air output point; 3.15, first track segment; 3.16, second track segment; 3.17, third track segment; 3.18, fourth track segment; 11.4, second rotation disk; 4.1, second cam slot; 4.11, second concentrated air output point; 4.12, second rightward air output point; 4.13, second leftward air output point, 4.14, second diffused air output point; 4.15, first travel segment; 4.16, second travel segment; 4.17, third travel segment; 4.18, fourth travel segment; 11.5, first drive rod; 5.1, first drive block; 5.2, guide block; 11.6, second drive rod; 6.1, second drive block; 6.2, guide slot; 11.7, actuator.

### DETAILED DESCRIPTION

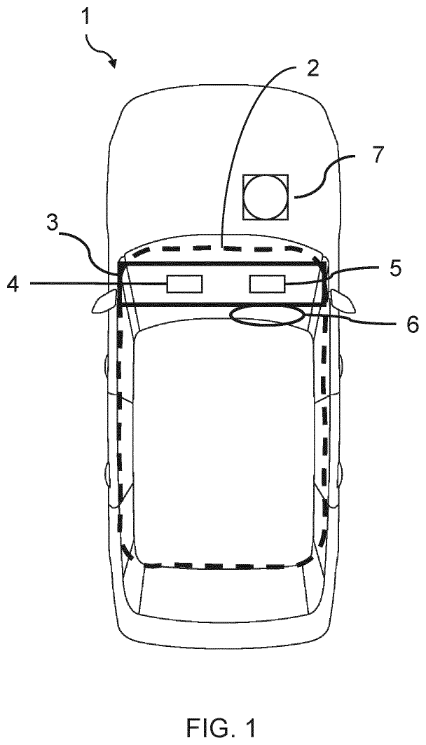

FIG. 1 shows a vehicle 1 in which the invention may be used. The vehicle 1 comprises a cabin 2 which defines an internal space of the vehicle allocated for the driver, passengers and storage. It is desirable that the environment within the cabin 2 be controlled to be comfortable for the driver and passengers, as well as to ensure a clear view out of the windscreen and windows (which may be prone to misting depending on the temperature and humidity conditions inside and outside of the vehicle).

The cabin 2 may be serviced by a variety of vents, each capable of delivering air into a different region (horizontal and/or vertical) of the vehicle cabin 2. Specific areas of the vehicle cabin 2 may be serviced by controlling the rate of air flow through a vent servicing that area and/or by adjusting the direction of one or more vents. For example, a first group of vents may comprise one or more face vents for directing air onto the face and upper body of a driver or front passenger. A second group of vents may comprise screen vents for directing air onto the windscreen and/or other cabin windows to provide a demisting function. A third group of vents may release air into the vehicle footwell. The present disclosure is principally concerned with the first group of vents, and in particular to a vent capable of providing adjustable directionality of airflow, but the invention in its application is not limited to face vents.

The vehicle cabin 2 is provided with an instrument panel 3 (including the dashboard and its instrumentation), within which a driver side vent 5 and a passenger side vent 4 are disposed. These are able to direct air towards the driver and passenger respectively. In accordance with the arrangement of the present disclosure, the driver side vent 5 is disposed behind a steering wheel 6 of the vehicle 1. Each of the vents 4, 5 comprises an outlet (aperture), not shown, in the instrument panel 3 having a cavity, also not shown, behind the outlet, within which are disposed horizontal and vertical vanes (discussed further below) which can be adjusted to direct the airflow out of the aperture. A vent assembly (not shown in FIG. 1) is disposed behind the instrument panel and includes the horizontal and vertical vanes as well as means for controlling the position (angle) of the horizontal and vertical vanes. Ducts (not shown in the interests of clarity) are also provided which provide a fluid (airflow) communication between a blower 7 (which drives air into the ducts) and the vents 4, 5. The present disclosure is concerned mainly, but not necessarily exclusively, with the adjustment of vertical vanes (which control the horizontal direction of airflow)—alternative implementations may apply the techniques described herein to horizontal (or diagonal) vanes, to affect adjustments in other directions of airflow.

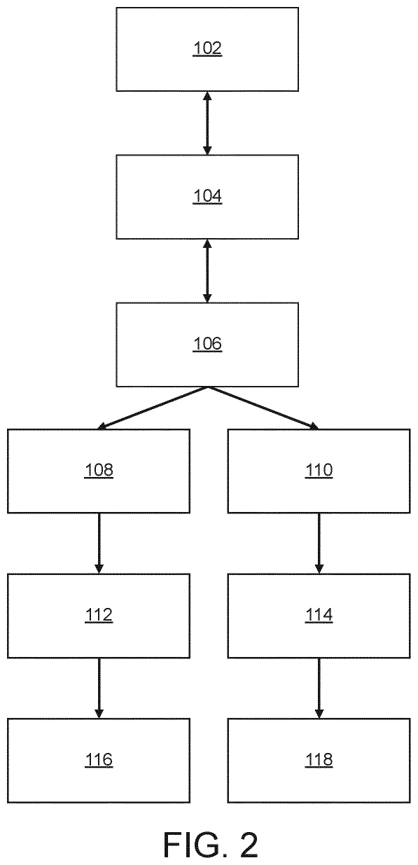

Referring to FIG. 2, a simplified vent assembly and control function for a vehicle cabin vent is shown to comprise a user interface 102, an electronic controller 104, a motor 106, a first cam 108, a second cam 110, a first cam follower 112, a second cam follower 114, a first set of vanes 116 and a second set of vanes 118. In operation, the user selects an airflow configuration for the vent using the user interface 102. This may involve the selection of a desired airflow mode, examples of which will be described subsequently. In response to the user selection, the controller 104 determines an amount by which an output shaft of the motor 106 is required to rotate to achieve the desired airflow configuration, and causes the motor 106 to be driven accordingly. The output shaft of the motor 106 is either directly or indirectly coupled to both the first cam 108 and the second cam 110. In particular, the first and second cams 108, 110 may both be provided on the output shaft of the motor 106, or may both be provided on a common shaft indirectly driven (for example via gears) by the motor 106. Each of the cams 108, 110 defines a different cam path, which is engaged by a respective one of the cam followers 112, 114. Since the two cam paths are different, the movement induced in the cam followers 112, 114 is also different (for at least a portion of the rotation of the shaft). The first follower 112 is connected to the first set of vanes 116, while the second follower 114 is connected to the second set of vanes 116. Since the first and second cam followers 112, 114 move differently (due to differences in the respective cam paths) at least for some of their movement cycles, the first and second sets of vanes 116, 118 also move differently. It will be appreciated that, since the two cam paths are driven to rotate together, the movement of the first and second sets of vanes is not independent, but it is different (for at least a portion of the rotation of the shaft). Thus, a single motor 106 is used to drive two sets of vanes 116, 118 within a vent to move differently, permitting multiple different airflow configurations to be achieved with a single motor.

In an alternative implementation, no user interface 102, electronic controller 104 or electric motor 106 are provided, and instead the first and second cams 108, 110 are commonly driven by manual actuation by a user of an input device, such as a dial. In this case, the first and second cams 108, 110 may still be mounted to a common shaft, but the common shaft is driven to rotate by manual manipulation of the input device by the user.

Referring to FIGS. 3A and 3B, a structural representation is provided of internal parts of the vent assembly described schematically above with reference to FIG. 2. In practice the parts shown in FIGS. 3A and 3B will be packaged into a housing and installed in an appropriate location within the cabin 2 of the vehicle (behind the instrument panel 3). As will be explained below, the vent is particularly well suited for installation within an instrument panel of the vehicle cabin, and most particularly directly in front of the driver, with the steering wheel 6 of the vehicle disposed between the driver and the vent. A similar vent may be provided in front of the front row passenger position, again within the instrument panel.

In FIGS. 3A and 3B, the vent assembly 200 can be seen to comprise a motor 206 having a common output shaft 207. A first cam wheel 208 and a second cam wheel 210 are each mounted to the common output shaft 207. The first cam wheel 208 and the second cam wheel 210 are parallel to and spaced apart from each other, and are in a radial plane with respect to the shaft 207. Each cam wheel bears a cam track, 209 and 211 respectively, on a planar surface thereof facing the other of the cam wheels. That is, the cam wheel 208 has a cam track 209 defined on a surface thereof facing the cam wheel 210, while the cam wheel 210 has a cam track 211 defined on a surface thereof facing the cam wheel 208. The cam tracks 209, 211 define cam paths. A first cam follower 212 and a second cam follower 214 are operably coupled to the cam wheels 208 and 210 respectively. More particularly, the first cam follower 212 is provided with a pin 213 at one end thereof, which engages with the cam track 209 of the first cam wheel 208. Similarly, the second cam follower 214 is provided with a pin 215 at one end thereof, which engages with the cam track 211 of the second cam wheel 210.

The ends of the first cam follower 212 and the second cam follower 214 bearing the pins 213, 215 respectively are disposed (and trapped) between the two cam wheels 208, 210. That is, with the pins 213, 215 engaging the respective cam tracks, portions of the cam followers 212, 214 in the vicinity of the pins 213, 215 (and in particular between the cam wheels 208, 210) are slidably abutted with each other such that the cam followers 212, 214 are able to move (in a constrained fashion) with respect to each other, without the pins 213, 215 escaping from the tracks 209, 211. The first and second cam followers 212, 214 are constrained (by means not shown) to move only along the longitudinal axes thereof which constitute an action-direction of the cam followers. The action-direction is most effectively radial with respect to the rotation axis of the shaft 207. As such, the permitted movement direction of the cam follower 212 and the permitted movement direction of the cam follower 214 are parallel. This constraining of movement of the cam followers 212, 214 may be achieved by a housing (not shown) in which the assembly is provided. The first cam follower 212 is coupled, at a position generally distal from the pin 213, to a set of vanes 216. In particular, the coupling is between the first cam follower 212 and each of the vanes 215 in the set 216. Each of the vanes 215 is rotatably mounted to the inside of the housing by respective pivots 217. As the first cam follower 212 moves along its longitudinal axis, it displaces lever 253 connected to a distributor lever 255 which is itself connected to all the vanes 251 (at a position on the vanes at a distance from the pivots 217). This enables the vanes 251 to rotate about the pivots 217, and thus to define different angles within the portion of the vent occupied by the vanes 216. This causes airflow through this portion of the vent to exit the vent in a different direction. Similarly, as the second cam follower 214 moves along its longitudinal axis, it is likewise connected to and displaces lever 263. It is connected to distributor lever 265, itself connected to each vane 261 of the second set 218 of vanes. The distributor lever 265 is connected to the vanes 261 at a position on the vanes at a distance from the pivots 219. This enables the vanes to rotate about the pivots 219, and thus to define different angles within the portion of the vent occupied by the set 218 of vanes. This causes airflow through this portion of the vent to exit the vent in a different direction. Since the two different portions of the vent respectively occupied by the first and second sets of vanes 216, 218 are able to direct air in different directions (from each other), very flexible control of airflow from the vent is possible.

From the above, it will be understood that the inner and outer (or put differently, the left and right) vertical vanes are split and able to be controlled separately (but not independently). As a result, in addition to the full forwards (neutral), left and right airflow directions provided by a traditional vent, extra modes can be delivered. This includes a diverged mode in which the air is directed away from the centre of the vent, this being appropriate for targeting high and missing the head of the driver or passenger, for a general cooling mode, and to avoid drying out a user's eyes or feeling air movement. It also includes a focused mode, in which air is aimed directly to the centre of the vent, which is appropriate for directly targeting at the face, for rapid cool down, whilst giving maximum opportunity to miss blockage by the steering wheel and hands on the steering wheel, and also reducing cold air flow to the hands.

In contrast to prior art arrangements, the provision of the focused mode makes it possible to channel airflow from both sides towards the centre of the vent, enabling the maximum plume of airflow to the face for rapid cool down on both drivers and passengers' sides. On the driver's side this also minimises airflow being blocked by the steering wheel and/or a user's hands on the steering wheel. This is beneficial for increasing cool airflow to the face, and away from the hands to avoid the hands becoming cold. By providing two round cam wheels rotating on the motor, each cam wheel driving sperate pins on the cam follower drive bars, enables both bars to be controlled at all times via one motor. This also ensures that no mechanical cross overs are required. Further, two full cam wheels with endless cam paths rotating on the motor driving separate pins on the drive bars, enables the motor to either turn clockwise or anticlockwise to get to the desired location, reducing the time required to achieve a requested airflow direction.

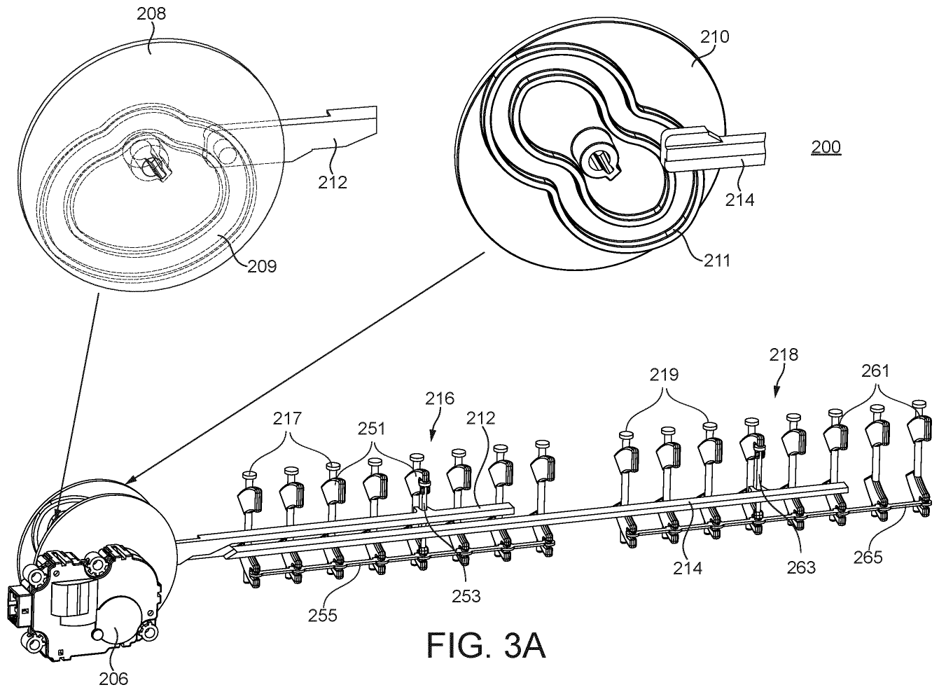

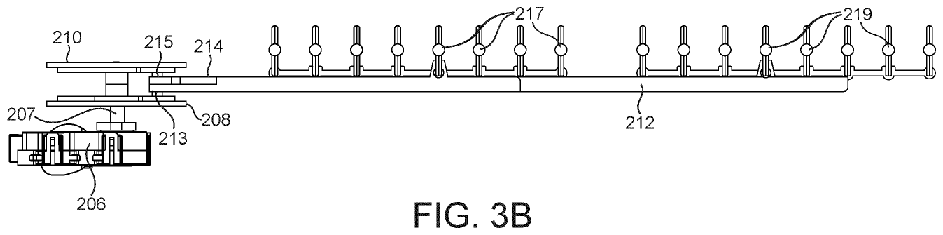

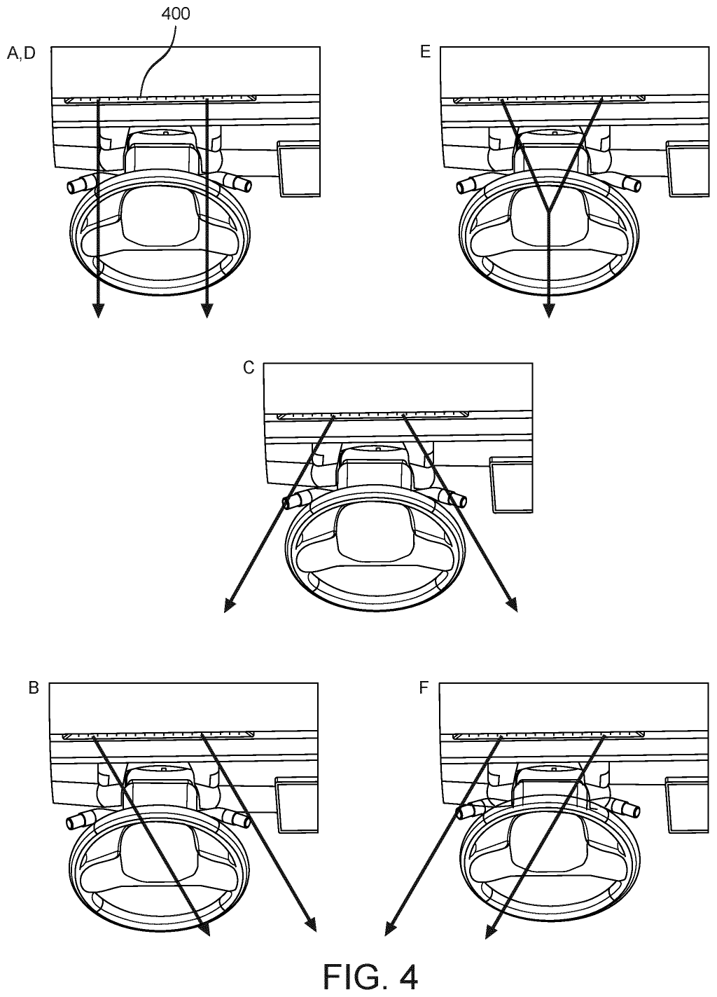

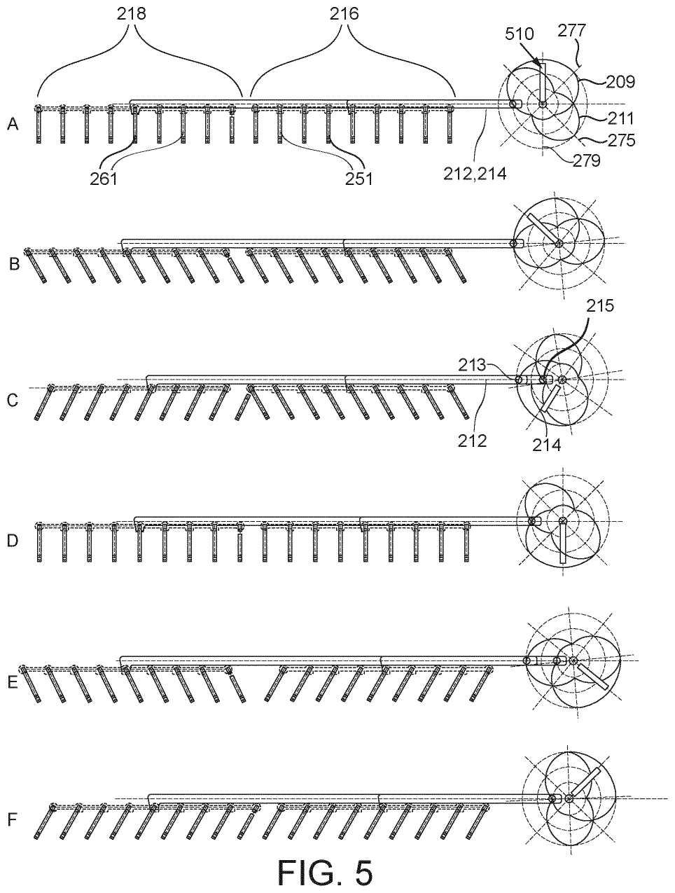

Referring to FIGS. 4 and 5, five different airflow configurations achievable using the present technique are shown (reference is also made to Table 1 above). In configuration A,D (neutral), both the first set of vanes 216 and the second set of vanes 218 are parallel to each other and substantially perpendicular with an output face of the vent 400. This causes airflow from the vent to be perpendicular to the face of the vent, and generally towards the driver (as shown in FIG. 4 (A,D), with the vent 400 behind the steering wheel 402), or alternatively towards a front passenger position within the vehicle cabin. In configuration E (focused), the first set of vanes 216 and the second set of vanes 218 are angled generally towards each other, so that airflow from the respective portions of the vent occupied by the first and second sets of vanes 216, 218 converges to form a focused, highly directed, airflow towards the driver (for example). This is particularly beneficial since it directs air through the steering wheel and between the driver's hands and arms, and onto their face and body. Conventionally, this level of directionality onto a driver has been difficult or impossible to achieve due to the steering wheel, arms and hands of the driver representing significant obstacles with vents disposed to the sides of the steering wheel. In configuration C (diverged) the first set of vanes 216 and the second set of vanes 218 are angled generally away from each other, so that airflow from the respective portions of the vent occupied by the first and second sets of vanes 216, 218 diverges. In this case, as with configuration E, airflow generally avoids the steering wheel and the driver's arms and hands, but in contrast with configuration E the airflow is not directed onto the driver, but is instead directed around the driver to cool the vehicle cabin more generally. In configuration B (inboard), the first set of vanes 216 and the second set of vanes 218 are parallel with each other and angled towards a first side of the vent, so that airflow from the respective portions of the vent occupied by the first and second sets of vanes 216, 218 exits the vent in a same direction, to provide cooling in the vehicle cabin to a first side of the vent. Similarly, in configuration F (outboard), the first set of vanes 216 and the second set of vanes 218 are parallel with each other and angled towards a second side of the vent (opposite to the first side), so that airflow from the respective portions of the vent occupied by the first and second sets of vanes 216, 218 exits the vent in a same direction, to provide cooling in the vehicle cabin at a second side of the vent.

FIG. 5 shows how rotation of the motor, and thus the two cam wheels, can give rise to the different configurations described with reference to FIG. 4 and in Table 1 above. In FIG. 5, illustrative output shaft position of the motor 206 is indicated by line 510. The positions of the tracks 209, 211 are also shown in FIG. 5. It can be seen that as the output shaft of the motor rotates (anticlockwise as shown progressively in FIG. 5, although as discussed elsewhere, clockwise rotation is also possible) through the various stages, the tracks/cam paths 209, 211 rotate with it. Where the cam paths 209, 211 coincide on the axis of the cam followers 212, 214, the vanes 251,261 adopt the same angular orientation. The vent configuration is shown progressively changing through stages A to F, as the output shaft rotates anti-clockwise (as viewed). At stage A in FIG. 5, the output shaft is at an initial position (0°). At this rotational position of the output shaft, both sets of vanes are parallel and in a neutral position, corresponding to the configuration A,D in FIG. 4 (A in Table 1). The motor 206 then rotates by 45°, to an angle of 315° at the stage B. Here, the two sets of vents are still parallel, but are now angled to direct air out to one side of the vent, corresponding to the configuration B in FIG. 4. The motor 206 then rotates a further 90°, to an angle of 225° at the stage C. Here, the two sets of vanes are angled away from each other, corresponding to the configuration C in FIG. 4. The motor 206 then rotates a further 45°, to an angle of 180° at a stage D. Here, the two sets of vanes are again parallel, and in the neutral position, corresponding to the configuration A,D in FIG. 4 (D in Table 1). The motor then rotates a further 45°, to an angle of 135° at a stage E. Here, the two sets of vanes are angled towards each other, corresponding to the configuration E in FIG. 4. The motor then rotates a further 90°, to an angle of 45° at a stage F. Here, the two sets of vanes are again parallel, but are now angled to direct air out of the other side of the vent (compared with stage B). This corresponds to the configuration F in FIG. 4. Completing the rotation, the motor may then move back to the original position of stage A, resuming the neutral configuration.

From this, it will be appreciated that, as the motor (and its output shaft) rotates, the two sets of vanes move. For certain portions of the rotation, such as between the stages A and B, and F and A, the two sets of vanes may move identically, for example remaining parallel and changing direction together.

For other portions of the rotation, such as between stages B and C, C and D, D and E and E and F (and the reverse directions thereof), the two sets of vanes move differently, resulting in relative movement (change in relative angle) between the vanes.

For completeness, the two angles of motor rotation not illustrated in FIG. 5, namely 270 degrees and 90 degrees (positions 3 and 7 in Table 1), the resulting orientations of the vanes would not normally be employed since it results in one set of vanes being in the neutral position and the other set directing air into the neutral forward flow, or away from it, neither of which has great application. Possibly the latter might have application for directing a portion of the flow through the steering wheel at a driver's face while the remainder is directed into the bulk of the cabin, but this loses the benefit of two air-streams colliding and being focused through the steering wheel and avoiding hands holding the steering wheel as evident from FIG. 4(E).

It will be appreciated that the motor 206 may be driven in either direction. For any given desired vent configuration, this can be reached either with clockwise or anti-clockwise rotation of the output shaft of the motor 206. However, the amount of rotation required may not be the same in both directions of rotation, depending on the current airflow configuration. Accordingly, it is desirable to select a direction of rotation of the motor depending on the current and desired vent configuration, which will require the smallest amount (angle) of rotation, since (assuming fixed motor speed) this can be achieved more quickly, and with the fewest intermediate (and unselected) stages. The controller is configured to select a direction of motor rotation, and an amount of motor rotation, in dependence on the current rotational position (current stage) and the desired vent configuration. This could, for example, be achieve by way of a lookup table. In FIG. 5, two neutral positions (corresponding to configuration A in FIG. 4) are provided. From the first neutral position (stage A), either inboard or outboard airflow directions (configurations B and F in FIG. 4) can be achieved without passing through any intermediate stages with just 45 degrees of motor rotation. From the second neutral position (stage D), either converged (configuration E) or diverged (configuration C) airflow can be achieved without passing through any intermediate stages.

With this method, by using a full rotation of an actuator (motor), it is possible to achieve any desired airflow direction in less time than a traditional cam controlled actuator. In particular, all desired airflow directions are provided at different rotational positions of the actuator and cams by defining the cam paths appropriately. Specifically, different cam paths are provided for each side of (set of) the vanes, and are driven off a single actuator, which enables robust and time efficient movement of vanes to get to customer desired position. It will be understood that, advantageously, a maximum of 180° of rotation is ever required to get to position (by utilising both directions of rotation).

The different cam paths may be as shown in the Figures, particularly in FIG. 3A, and in FIG. 5. One of the paths (a first path defined by the track 211) may have rotational symmetry of order 2 about its axis of rotation (and two orthogonal planes 275, 277 of mirror symmetry—see FIG. 5(A)), while the second path, defined by the track 209 may have no rotational symmetry (and one plane 279 of mirror symmetry). The first path may comprise two lobes of substantially equal size at opposite sides of the rotational axes of the paths, and the second path may comprise a generally elliptical shape with a single side lobe, smaller than the elliptical shape. The planes of symmetry 275, 277 of the first path 211 are respectively offset by 45 degrees with respect to the plane of symmetry 279 of the second path 209. Together, these shaped cam paths are able to deliver the various configurations described herein. The shape of the cam paths define the order of ‘modes’ (vane configurations) the customer or motor can cycle through.

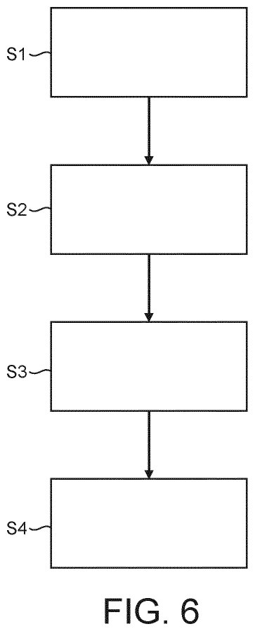

Referring to FIG. 6, as well as FIG. 2, a schematic flow diagram is provided which explains the process of vent adjustment using the present apparatus described above. At a step S1, a user interacts with the user interface 102 to select a desired vent configuration. This may for example involve interacting with a touchscreen display or manipulating a physical input control such as a switch or dial. At a step S2, the controller 104 determines a direction and amount of rotation required to achieve the desired vent configuration based on the present rotational position of the motor output shaft and cam wheels. At a step S3 the motor is driven, generally at a predetermined speed, until the output shaft upon which the cam wheels are disposed has rotated to the correct angle for the desired vent configuration. At a step S4 the motor stops and the process of adjustment ends. The process of FIG. 6 is repeated the next time the user selects a different vent configuration.

It will be understood that there is substantial overlap between the first embodiment and the second and third embodiments described below and that features of the following embodiments may be used in combination with the first embodiment where those features are technically compatible.

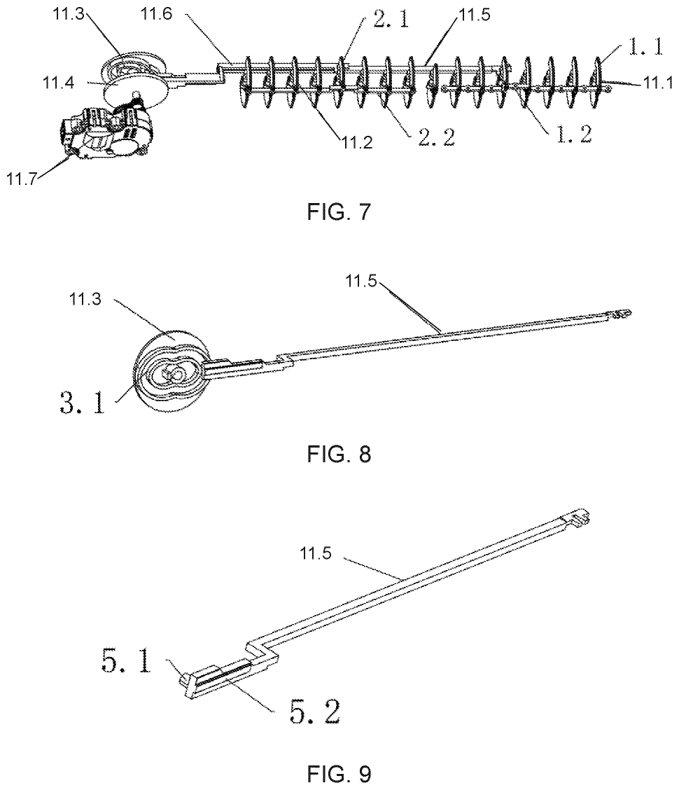

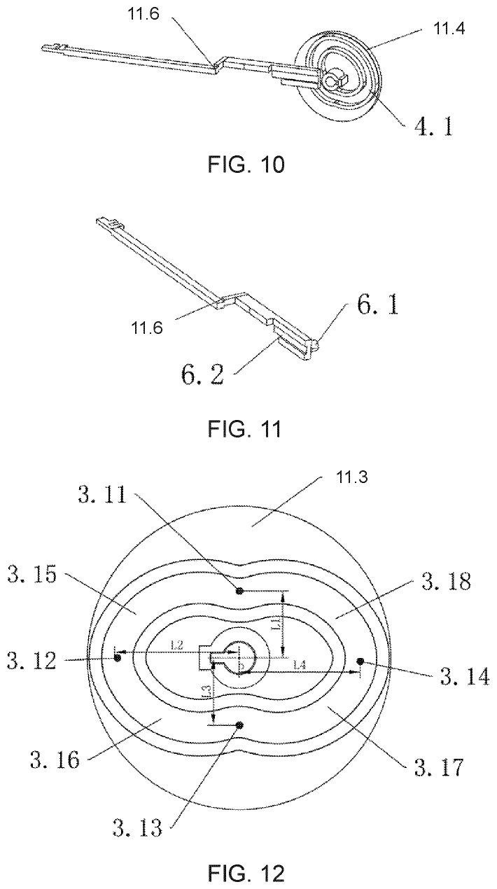

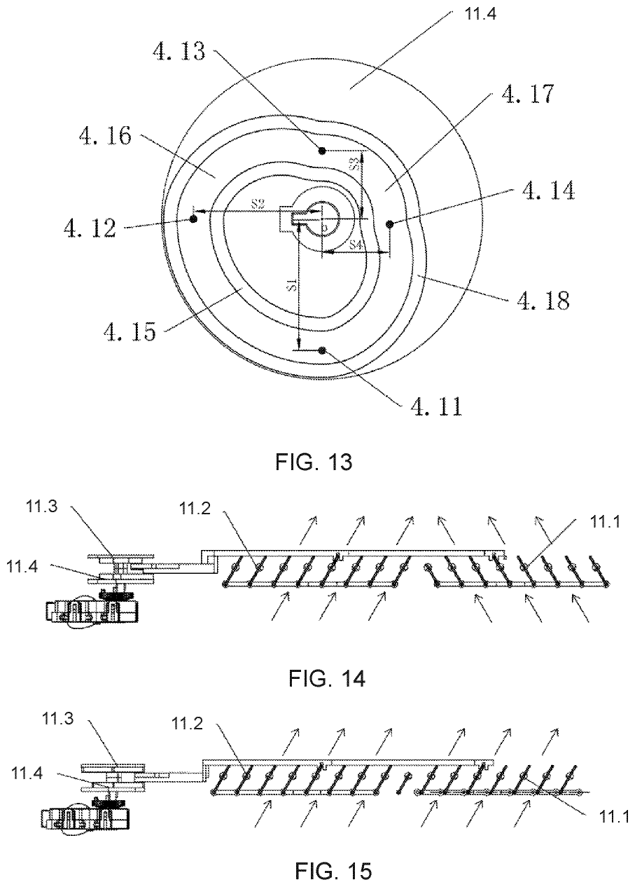

Referring to FIG. 7 to FIG. 13, an air output device for an automobile air conditioner includes a housing, a rotation assembly, a drive assembly, a first blade set 11.1, and a second blade set 11.2. An air output channel is formed in the housing. An air output region is formed at an outlet of the air output channel. The first blade set 11.1 and the second blade set 11.2 are respectively provided in the housing. The first blade set 11.1 includes at least one first airflow guide blade 1.1 oscillating from side to side in an X direction. The second blade set 11.2 includes at least one second airflow guide blade 2.1 oscillating from side to side in the X direction. In this embodiment, the X direction is a transverse direction, and is perpendicular to a rotation axis of the first airflow guide blade 1.1. A plurality of first airflow guide blades 1.1 and a plurality of second airflow guide blades 2.1 are respectively provided. The plurality of first airflow guide blades 1.1 are connected to each other by means of a first connecting rod 1.2 so as to be movably linked. The plurality of second airflow guide blades 2.1 are connected to each other by means of a second connecting rod 2.2 so as to be movably linked. The first airflow guide blades 1.1 rotate to adjust left and right air output angles. The second airflow guide blades 2.1 also rotate to adjust left and right air output angles. The first airflow guide blades 1.1 and the second airflow guide blades 2.1 are arranged side by side. The first airflow guide blades 1.1 are on the right side, and the second airflow guide blades 2.1 are on the left side.

The rotation assembly includes a first rotation disk 11.3 and a second rotation disk 11.4 that are connected to each other by means of a fastener, so that the first rotation disk 11.3 and the second rotation disk 11.4 can rotate synchronously. The first rotation disk 11.3 has a first cam slot 3.1. The second rotation disk 11.4 has a second cam slot 4.1. The first cam slot 3.1 is provided on a surface of the first rotation disk 11.3 facing the second rotation disk 11.4. The second cam slot 4.1 is provided on a surface of the second rotation disk 11.4 facing the first rotation disk 11.3.

The drive assembly includes a first drive rod 11.5 drivingly connected to the first blade set 11.1 and a second drive rod 11.6 drivingly connected to the second blade set 11.2. The first drive rod 11.5 is parallel with the first connecting rod 1.2. The second drive rod 11.6 is parallel with the second connecting rod 2.2.

One end of the first drive rod 11.5 is provided with a first drive block 5.1 extending into the first cam slot 3.1, and the other end of the first drive rod 11.5 extends in the X direction towards the air output region, and is drivingly connected to one of the first airflow guide blades 1.1, so that the first drive rod 11.5, when moving, can drive the plurality of first airflow guide blades 1.1 to oscillate synchronously. One end of the second drive rod 11.6 is provided with a second drive block 6.1 extending into the second cam slot 4.1, and the other end of the second drive rod 11.6 extends in the X direction towards the air output region, and is drivingly connected to one of the second airflow guide blades 2.1, so that the second drive rod 11.6, when moving, can drive the plurality of second airflow guide blades 2.1 to oscillate synchronously.

The first drive rod 11.5 and the second drive rod 11.6 are adjacent to each other. One of the first drive rod 11.5 and the second drive rod 11.6 is provided with a guide slot 6.2 along a straight line, and the other is provided with a guide block 5.2 extending into the guide slot 6.2. In this embodiment, the first drive rod 11.5 is provided with the guide block 5.2, and the second drive rod 11.6 is provided with the guide slot 6.2, and the guide block 5.2 extends into the guide slot 6.2. By means of engagement between the guide block 5.2 and the guide slot 6.2, the first drive rod 11.5 and the second drive rod 11.6 can guide each other, so that the first drive rod 11.5 and the second drive rod 11.6 can perform rectilinear movement only along a slide slot and the guide slot 6.2.

The first drive rod 11.5 and the second drive rod 11.6 can respond to action of the first cam slot 3.1 and the second cam slot 4.1 so as to directionally drive the first blade set 11.1 and the second blade set 11.2 to oscillate.

Specifically, the first cam slot 3.1 has, in sequence, a first concentrated air output point 3.11, a first rightward air output point 3.12, a first leftward air output point 3.13, and a first diffused air output point 3.14. The first cam slot 3.1 is ring-shaped as a whole. The first concentrated air output point 3.11, the first rightward air output point 3.12, the first leftward air output point 3.13, and the first diffused air output point 3.14 are annularly arranged. The first concentrated air output point 3.11, the first rightward air output point 3.12, the first leftward air output point 3.13, and the first diffused air output point 3.14 separate the first cam slot 3.1 into four segments. That is, the first cam slot 3.1 is provided with a first track segment 3.15 between the first concentrated air output point 3.11 and the first rightward air output point 3.12, is provided with a second track segment 3.16 between the first rightward air output point 3.12 and the first leftward air output point 3.13, is provided with a third track segment 3.17 between the first leftward air output point 3.13 and the first diffused air output point 3.14, and is provided with a fourth track segment 3.18 between the first diffused air output point 3.14 and the first concentrated air output point 3.11. Distances from the first concentrated air output point 3.11, the first rightward air output point 3.12, the first leftward air output point 3.13, and the first diffused air output point 3.14 to the center of rotation of the first rotation disk 11.3 in the rotation assembly are respectively L1, L2, L3, and L4, where L2=L4>L1=L3.

The second cam slot 4.1 has, in sequence, a second concentrated air output point 4.11, a second rightward air output point 4.12, a second leftward air output point 4.13, and a second diffused air output point 4.14. The second cam slot 4.1 is ring-shaped as a whole. The second concentrated air output point 4.11, the second rightward air output point 4.12, the second leftward air output point 4.13, and the second diffused air output point 4.14 are annularly arranged. The second concentrated air output point 4.11, the second rightward air output point 4.12, the second leftward air output point 4.13, and the second diffused air output point 4.14 separate the first cam slot 3.1 into four segments. The second cam slot 4.1 the second cam slot 4.1 is provided with a first travel segment 4.15 between the second concentrated air output point 4.11 and the second rightward air output point 4.12, is provided with a second travel segment 4.16 between the second rightward air output point 4.12 and the second leftward air output point 4.13, is provided with a third travel segment 4.17 between the second leftward air output point 4.13 and the second diffused air output point 4.14, and is provided with a fourth travel segment 4.18 between the second diffused air output point 4.14 and the second concentrated air output point 4.11.

Distances from the second concentrated air output point 4.11, the second rightward air output point 4.12, the second leftward air output point 4.13, and the second diffused air output point 4.14 to the center of rotation of the second rotation disk 11.4 in the rotation assembly are respectively S11.1, S11.2, S11.3, and S11.4, where S11.1=S11.2>S11.3=S11.4. a. When rotating, the rotation assembly drives the first drive block 5.1 to sequentially pass through the first concentrated air output point 3.11, the first rightward air output point 3.12, the first leftward air output point 3.13, and the first diffused air output point 3.14, while driving the second drive block 6.1 to sequentially pass through the second concentrated air output point 4.11, the second rightward air output point 4.12, the second leftward air output point 4.13, and the second diffused air output point 4.14. The second drive block 6.1 is at the second concentrated air output point 4.11 when the first drive block 5.1 is at the first concentrated air output point 3.11. The second drive block 6.1 is at the second rightward air output point 4.12 when the first drive block 5.1 is at the first rightward air output point 3.12. The second drive block 6.1 is at the second leftward air output point 4.13 when the first drive block 5.1 is at the first leftward air output point 3.13. The second drive block 6.1 is at the second diffused air output point 4.14 when the first drive block is at the first diffused air output point 3.14.

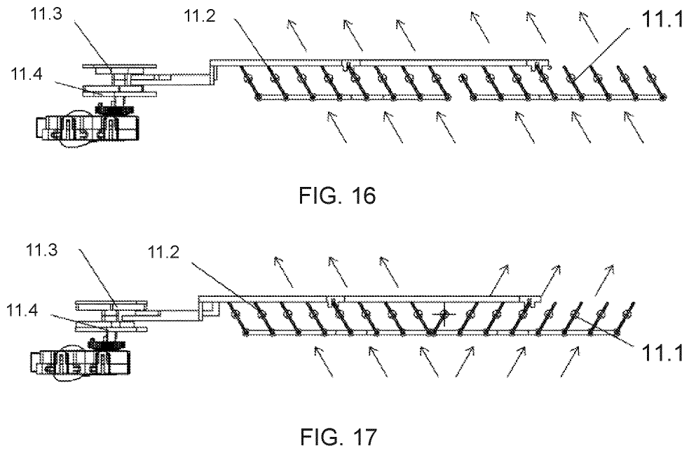

Referring to FIG. 14 to FIG. 17, during rotation of the rotation assembly, motion states of the first airflow guide blades 1.1 and the second airflow guide blades 2.1 are specifically as follows: S11.1, when the first drive block 5.1 is at the first concentrated air output point 3.11, the first airflow guide blades 1.1 are driven to tilt towards the second airflow guide blades 2.1 (that is, tilt to the left), and the second drive block 6.1 is at the second concentrated air output point 4.11, and the second airflow guide blades 2.1 are driven to tilt towards the first airflow guide blades 1.1 (that is, tilt to the right). In this case, the first airflow guide blades 1.1 and the second airflow guide blades 2.1 cooperate to achieve concentrated air output.

S11.2, the rotation assembly continues to rotate, so that when the first drive block 5.1 switches from the first concentrated air output point 3.11 along the first track segment 3.15 to the first rightward air output point 3.12, the first track segment 3.15 engages with the first drive block 5.1. Since L2>L1, the first drive block 5.1 and the first drive rod 11.5 are driven to move away from the center of rotation of the first rotation disk 11.3 in the rotation assembly. Therefore, the first drive rod 11.5 drives the first airflow guide blades 1.1 to oscillate to the right, so that when the first drive block 5.1 is at the first rightward air output point 3.12, the first airflow guide blades 1.1 tilt to the right.

The second drive block 6.1 switches from the second concentrated air output point 4.11 along the first travel segment 4.15 to the second rightward air output point 4.12, and the second travel segment 4.15 engages with the second drive block 6.1. Since S11.1=S11.2, the first travel segment 4.15 is idle, and the positions of the second drive block 6.1 and the second drive rod 11.6 remain unchanged. Therefore, the second airflow guide blades 2.1 remain tilting towards the first airflow guide blades 1.1 (that is, tilt to the right). In this case, the first airflow guide blades 1.1 and the second airflow guide blades 2.1 cooperate to achieve rightward air output.

S11.3, the rotation assembly continues to rotate, so that when the first drive block 5.1 switches from the first rightward air output point 3.12 along the second track segment 3.16 to the first leftward air output point 3.13, the second track segment 3.16 engages with the first drive block 5.1. Since L3<L2, the first drive block 5.1 and the first drive rod 11.5 are driven to move towards the center of rotation of the first rotation disk 11.3 in the rotation assembly. Therefore, the first drive rod 11.5 drives the first airflow guide blades 1.1 to oscillate to the left, so that when the first drive block 5.1 is at the first leftward air output point 3.13, the first airflow guide blades 1.1 tilt to the left.

The second drive block 6.1 switches from the second rightward air output point 4.12 along the second travel segment 4.16 to the second leftward air output point 4.13, and the second travel segment 4.16 engages with the second drive block 6.1. Since S11.3<S11.2, the second drive block 6.1 and the second drive rod 11.6 are driven to move towards the center of rotation of the second rotation disk 11.4 in the rotation assembly. Therefore, the second drive rod 11.6 drives the second airflow guide blades 2.1 to oscillate to the left, so that when the second drive block 6.1 is at the second leftward air output point 4.13, the second airflow guide blades 2.1 tilt to the left. In this case, the first airflow guide blades 1.1 and the second airflow guide blades 2.1 cooperate to achieve leftward air output.

S11.4, the rotation assembly continues to rotate, so that when the first drive block 5.1 switches from the first leftward air output point 3.13 along the third track segment 3.17 to the first diffused air output point 3.14, the third track segment 3.17 engages with the first drive block 5.1. Since L4>L3, the first drive block 5.1 and the first drive rod 11.5 are driven to move away from the center of rotation of the first rotation disk 11.3 in the rotation assembly. Therefore, the first drive rod 11.5 drives the first airflow guide blades 1.1 to oscillate to the right, so that when the first drive block 5.1 is at the first diffused air output point 3.14, the first airflow guide blades 1.1 tilt to the right.

The second drive block 6.1 switches from the second leftward air output point 4.13 along the third travel segment 4.17 to the second diffused air output point 4.14, and the third travel segment 4.17 engages with the second drive block 6.1. Since S11.4=S11.3, the third travel segment 4.17 is idle. When the second drive block 6.1 reaches the second diffused air output point 4.14, the positions of the second drive block 6.1 and the second drive rod 11.6 remain unchanged, so that the second airflow guide blades 2.1 remain tilting towards the first airflow guide blades 1.1 (that is, tilt to the left). In this case, the first airflow guide blades 1.1 and the second airflow guide blades 2.1 cooperate to achieve diffused air output.

S5, the rotation assembly continues to rotate, so that when the first drive block 5.1 switches from the first diffused air output point 3.14 along the fourth track segment 3.18 to the first concentrated air output point 3.11, the fourth track segment 3.18 engages with the first drive block 5.1. Since L1<L4, the first drive block 5.1 and the first drive rod 11.5 are driven to move towards the center of rotation of the first rotation disk 11.3 in the rotation assembly. Therefore, the first drive rod 11.5 drives the first airflow guide blades 1.1 to oscillate to the left, so that when the first drive block 5.1 is at the first concentrated air output point 3.11, the first airflow guide blades 1.1 tilt to the left.

The second drive block 6.1 switches from the second diffused air output point 4.14 along the fourth travel segment 4.18 to the second concentrated air output point 4.11, and the fourth travel segment 4.18 engages with the second drive block 6.1. Since S11.1>S11.4, the second drive block 6.1 and the second drive rod 11.6 are driven to move away from the center of rotation of the second rotation disk 11.4 in the rotation assembly. Therefore, the second drive rod 11.6 drives the second airflow guide blades 2.1 to oscillate to the right, so that the second airflow guide blades 2.1 tilt to the right. In this case, the first airflow guide blades 1.1 and the second airflow guide blades 2.1 cooperate to achieve concentrated air output. In this case, the process returns to S11.1, thereby completing one movement cycle.

In this embodiment, the air output device further includes an electric actuator 11.7. The actuator 11.7 is drivingly connected to the rotation assembly so as to drive the rotation assembly to perform circular rotation, thereby achieving automated air output. In addition, in another embodiment, rotation of the rotation assembly may also be manually driven.

In the air output device of the present invention, the first cam slot 3.1 and the second cam slot 4.1 are provided. During use, the rotation assembly rotates, the first cam slot 3.1 engages with the first drive block 5.1 to define a movement path of the first drive block 5.1, and the second cam slot 4.1 engages with the second drive block 6.1 to define a movement path of the second drive block 6.1, thereby enabling the first drive rod 11.5 and the second drive rod 11.6 to move. When moving, the first drive rod 11.5 drives the first airflow guide blades 1.1 to oscillate. When moving, the second drive rod 11.6 drives the second airflow guide blades 2.1 to oscillate. When the first airflow guide blades 1.1 and the second airflow guide blades 2.1 oscillate, the first airflow guide blades 1.1 and the second airflow guide blades 2.1 can oscillate outwards in opposite directions so as to achieve diffused air output, can oscillate inwards in opposite directions so as to achieve concentrated air output, and can oscillate in the same direction so as to adjust an air output angle. The two sets of airflow guide blades can be adjusted by using one rotation assembly, thereby achieving a simple structure and easy adjustment, reducing the number of parts, costs and the overall size, and allowing the air output device to be easily arranged in an automobile. In addition, the rotation disks are configured to be located away from the air output region, so that air output is not affected. In addition, the respective other ends of the first drive rod 11.5 and the second drive rod 11.6 both extend in the X direction towards the air output region, so that the air output region is less affected, thereby ensuring the final air output performance.

It will be understood that there is substantial overlap between the second embodiment and the first and third embodiments described above and below and that features of the following embodiments may be used in combination with the first embodiment where those features are technically compatible.

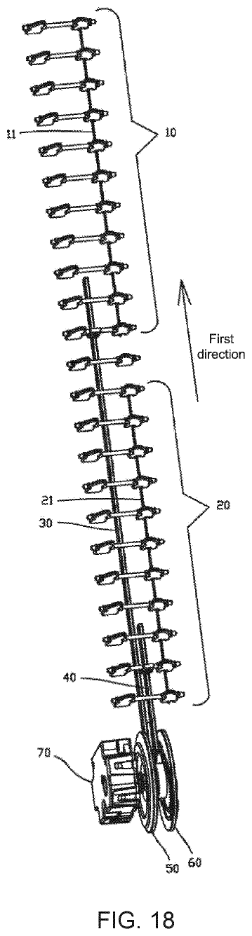

As shown in FIG. 18, an air outlet blade adjustment mechanism of this embodiment includes a first blade set 10, a second blade set 20, a first shift fork 30, a second shift fork 40, a first drive member 50, a second drive member 60, and a power device 70.

The first blade set 10 includes a plurality of airflow guide blades 100 arranged at intervals in a first direction and rotatably provided in an air outlet. All of the airflow guide blades 100 in the first blade set 10 are transmissively connected by means of a first connecting rod 11 so as to rotate synchronously. It will be understood that by transmissively connected it is meant that the airflow guide blades 100 in the first blade set 10 are connected in such a manner that movement of one is transmitted to the others by way of the first connecting rod 11 so as to rotate synchronously. The first connecting rod 11 is hinge-connected to all of the airflow guide blades 100 in the first blade set 10. The second blade set 20 includes a plurality of airflow guide blades 100 arranged at intervals in the first direction and rotatably provided in the air outlet. All of the airflow guide blades 100 in the second blade set 20 are transmissively connected by means of a second connecting rod 21 so as to rotate synchronously. The second connecting rod 21 is hinge-connected to all of the airflow guide blades 100 in the second blade set 20. The first blade set 10 and the second blade set 20 constitute vertical blades of the air outlet.

The first shift fork 30 is configured to move only in the first direction. The first shift fork 30 is connected to one of the airflow guide blades 100 in the first blade set 10. When moving in the first direction, the first shift fork 30 can drive the airflow guide blades 100 in the first blade set 10 to rotate. The second shift fork 40 is configured to move only in the first direction. The second shift fork 40 is connected to one of the airflow guide blades 100 in the second blade set 20. When moving in the first direction, the second shift fork 40 can drive the airflow guide blades 100 in the second blade set 20 to rotate. The first drive member 50 is connected to the first shift fork 30. The first drive member 50 rotates to drive the first shift fork 30 to be displaced in the first direction. When displaced in the first direction, the first shift fork 30 can drive the airflow guide blades 100 in the first blade set 10 to rotate, so as to adjust an angle of the first blade set 10. The second drive member 60 is connected to the second shift fork 40. The second drive member 60 rotates to drive the second shift fork 40 to be displaced in the first direction. When displaced in the first direction, the second shift fork 40 can drive the airflow guide blades 100 in the second blade set 20 to rotate, so as to adjust an angle of the second blade set 20.

The power device 70 may be a motor. The power device 70 includes a drive shaft. The drive shaft is connected to the first drive member 50 and the second drive member 60. The power device 70 is used to drive, by means of the drive shaft, the first drive member 50 and the second drive member 60 to rotate synchronously. A rotation angle of the drive shaft includes a plurality of consecutive rotation angle intervals, and displacement amounts and/or displacement directions of the first shift fork 30 and the second shift fork 40 are different in at least one of the rotation angle intervals.

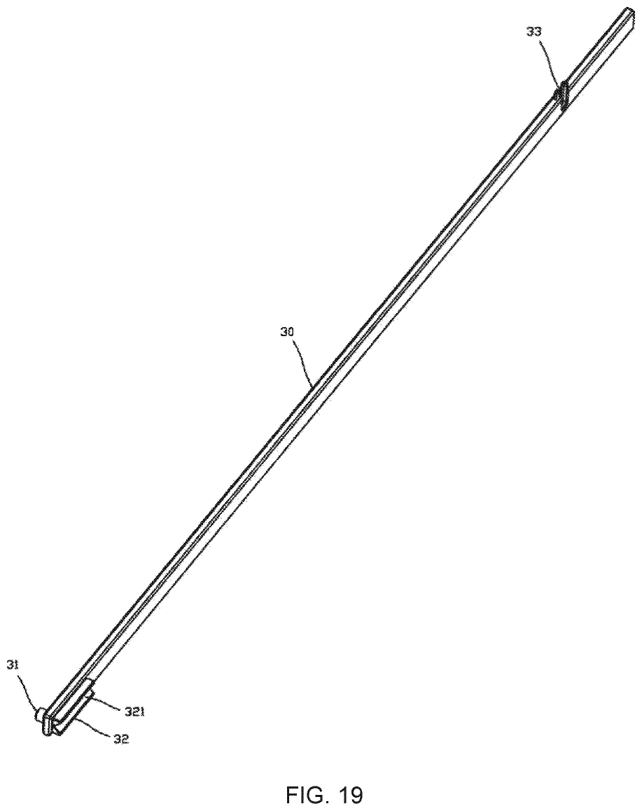

As shown in FIG. 19 and FIG. 22, the first drive member 50 is provided with a first mounting surface parallel with the first direction. The first mounting surface is provided with a first track slot portion 51. The first track slot portion 51 has a slot bottom and two side walls. The first shift fork 30 is provided with a first connecting portion 31. The first connecting portion 31 is fixedly connected to the first shift fork 30. The first connecting portion 31 is inserted in and connected to the first track slot portion 51. The first shift fork 30 is parallel with the first mounting surface. The first connecting portion 31 is movable in the first track slot portion 51. When the first drive member 50 rotates, the side wall of the first track slot portion 51 pushes the first connecting portion 31 so that the first shift fork 30 moves in the first direction.

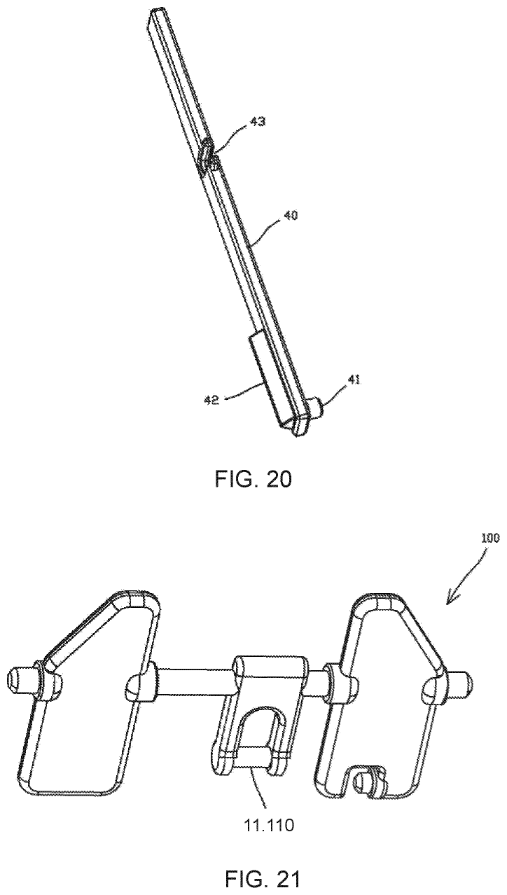

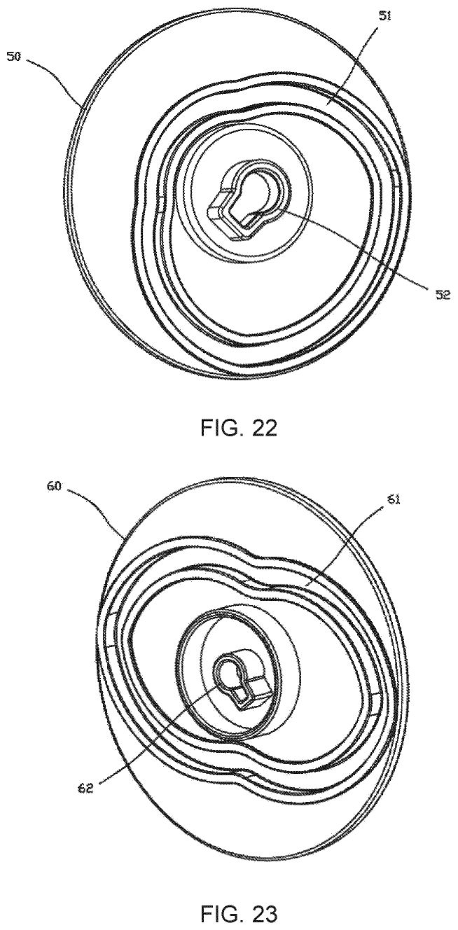

As shown in FIG. 20 and FIG. 23, the second drive member 60 is provided with a second mounting surface parallel with the first direction. The second mounting surface is provided with a second track slot portion 61. The second track slot portion 61 has a slot bottom and two side walls. The second shift fork 40 is provided with a second connecting portion 41. The second connecting portion 41 is fixedly connected to the second shift fork 40. The second connecting portion 41 is inserted in and connected to the second track slot portion 61. The second shift fork 40 is parallel with the second mounting surface. The second connecting portion 41 is movable in the second track slot portion 61. When the second drive member 60 rotates, the side wall of the second track slot portion 61 pushes the second connecting portion 41 so that the second shift fork 40 moves in the first direction.

Extension tracks of the first track slot portion 51 and the second track slot portion 61 are different, so that when the first drive member 50 and the second drive member 60 rotate synchronously, movement displacement amounts and/or displacement directions of the first shift fork 30 and the second shift fork 40 in the first direction are different, and therefore angles of the airflow guide blades in the first blade set 10 and the second blade set 20 are different.

Transit axes of the first drive member 50 and the second drive member 60 coincide with the axis of the drive shaft of the power device 70.

As shown in FIG. 22 and FIG. 23, a first position-limiting portion 52 is fixed on the first drive member 50, is in the shape of a sleeve, and has a non-circular structure, and a second position-limiting portion 62 is fixed on the second drive member 60, is in the shape of a sleeve, and has a non-circular structure. The second position-limiting portion 62 and the first position-limiting portion 52 have the same shape, but have different sizes. The size of the first position-limiting portion 52 is greater than that of the second position-limiting portion 62. The first position-limiting portion 52 and the second position-limiting portion 62 are sleeved on each other, and position-limited circumferentially. The drive shaft of the power device 70 is connected to the first drive member 50 to drive the first drive member 50 to rotate, and the first drive member 50 drives the second drive member 60 to rotate synchronously.

As shown in FIG. 19 and FIG. 20, a bump 32 is fixed on the first shift fork 30, and is provided with a chute 321 extending in the first direction. The chute 321 passes through two ends of the bump 32. A cross section of the chute 321 is triangular. A slider 42 having a shape matching a shape of the chute 321 is fixed on the second shift fork 40. A cross section of the slider 42 is triangular. The first shift fork 30 and the second shift fork 40 are parallel with each other, and are close to each other. The slider 42 is slidably provided in the chute 321. When the displacement amounts of the first shift fork 30 and the second shift fork 40 in the first direction are different, the slider 42 may slide along the chute 321, so that the first shift fork 30 and the second shift fork 40 move relative to each other. In this manner, the first shift fork 30 and the second shift fork 40 do not need to be respectively provided with slide seats. The first shift fork 30 and the second shift fork 40 collectively form a slide structure, thereby reducing components, and simplifying the structure.

As shown in FIG. 19, FIG. 20, and FIG. 21, the first shift fork 30 is provided with a first notch 33, and one of the airflow guide blades 100 in the first blade set 10 has a drive rod portion 11.110 extending into the first notch 33. When the first shift fork 30 moves in the first direction, the first shift fork 30 exerts a pushing force to the drive rod portion 11.110 via the first notch 33, so as to push the airflow guide blade 100 to rotate. In this case, the drive rod portion 11.110 slides relatively in the first notch 33 in the depth direction of the first notch 33, so that the first shift fork 30 and the airflow guide blade 100 are not prone to jam each other.

The second shift fork 40 is provided with a second notch 43, and one of the airflow guide blades 100 in the second blade set 20 has a drive rod portion 11.110 extending into the second notch 43. When the second shift fork 40 moves in the first direction, the second shift fork 40 exerts a pushing force to the drive rod portion 11.110 via the second notch 43, so as to push the airflow guide blade 100 to rotate. In this case, the drive rod portion 11.110 slides relatively in the second notch 43 in the depth direction of the second notch 43, so that the second shift fork 40 and the airflow guide blade 100 are not prone to jam each other.

An electric air outlet assembly in this embodiment includes the air outlet blade adjustment mechanism. A vehicle in this embodiment includes the electric air outlet assembly.

When the air outlet blade adjustment mechanism of the present invention operates, if the drive shaft of the power device does not rotate, the airflow guide blades in the first blade set 10 and the second blade set 20 are all at 0 degrees, and this is an initial angle of the first blade set 10 and the second blade set 20.

When an output shaft of the power device rotates from 0 degrees to 45 degrees, all of the airflow guide blades in the first blade set and the second blade set rotate to the right from the initial angle by 40 degrees.

When the output shaft of the power device continues to rotate from 45 degrees to 90 degrees, the airflow guide blades in the first blade set do not move, and all of the airflow guide blades in the second blade set rotate to 0 degrees from 40 degrees to the right.

When the output shaft of the power device continues to rotate from 90 degrees to 135 degrees, the airflow guide blades in the first blade set do not move, and all of the airflow guide blades in the second blade set rotate to the left from 0 degrees to 40 degrees.

When the output shaft of the power device continues to rotate from 135 degrees to 180 degrees, all of the airflow guide blades in the first blade set rotate to 0 degrees from 40 degrees to the right, and all of the airflow guide blades in the second blade set rotate to 0 degrees from 40 degrees to the left.

When the output shaft of the power device continues to rotate from 180 degrees to 225 degrees, all of the airflow guide blades in the first blade set rotate to the left by 40 degrees from 0 degrees, and all of the airflow guide blades in the second blade set rotate to the right by 40 degrees from 0 degrees.

When the output shaft of the power device continues to rotate from 225 degrees to 270 degrees, the airflow guide blades in the first blade set do not move, and all of the airflow guide blades in the second blade set rotate to 0 degrees from 40 degrees to the right.

When the output shaft of the power device continues to rotate from 270 degrees to 315 degrees, the airflow guide blades in the first blade set do not move, and all of the airflow guide blades in the second blade set rotate to the left by 40 degrees from 0 degrees.

When the output shaft of the power device continues to rotate from 315 degrees to 360 degrees, all of the airflow guide blades in the first blade set rotate to 0 degrees from 40 degrees to the left, and all of the airflow guide blades in the second blade set rotate to 0 degrees from 40 degrees to the left.

The angle relationship between the first blade set 10 and the second blade set 10 may be adjusted by changing tracks of the first track slot portion 51 and the second track slot portion 61.

It will be understood that there is substantial overlap between the third embodiment and the first and second embodiments described above and that features of the following embodiments may be used in combination with the first embodiment where those features are technically compatible.

It is to be understood that a controller to give effect to the above described steps can comprise a control unit or computational device having one or more electronic processors (e.g., a microprocessor, a microcontroller, an application specific integrated circuit (ASIC), etc.), and may comprise a single control unit or computational device, or alternatively different functions of the or each controller may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller to implement the control techniques described herein (including some or all of the functionality required for the method described herein). The set of instructions could be embedded in said one or more electronic processors of the controller; or alternatively, the set of instructions could be provided as software to be executed in the controller.

The or each controller typically may comprise at least one electronic processor having one or more electrical input(s) for receiving one or more input signals and one or more electrical output(s) for outputting one or more output signals. The or each controller may further comprises at least one memory device electrically coupled to the at least one electronic processor and having instructions stored therein. The at least one electronic processor may be configured to access the at least one memory device and execute the instructions thereon so as to enable implementation of the above described method.

The, or each, electronic processor may comprise any suitable electronic processor (e.g., a microprocessor, a microcontroller, an ASIC, etc.) that is configured to execute electronic instructions. The, or each, electronic memory device may comprise any suitable memory device and may store a variety of data, information, threshold value(s), lookup tables or other data structures, and/or instructions therein or thereon. In an embodiment, the memory device has information and instructions for software, firmware, programs, algorithms, scripts, applications, etc. stored therein or thereon that may govern all or part of the methodology described herein. The processor, or each, electronic processor may access the memory device and execute and/or use that or those instructions and information to carry out or perform some or all of the functionality and methodology describe herein.

The at least one memory device may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

It will be appreciated that various changes and modifications can be made to the present invention without departing from the scope of the present application.

The blocks illustrated in FIG. 6 may represent steps in a method and/or sections of code in a computer program. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.
1. An air output device for an automobile air conditioner, comprising a rotation assembly, a drive assembly, and a first blade set and a second blade set provided in an air output region, the first blade set comprising at least one first airflow guide blade oscillating from side to side in an X direction, and the second blade set comprising at least one second airflow guide blade oscillating from side to side in the X direction, the air output device being characterized in that: the rotation assembly comprises at least one rotation disk located away from the air output region, an end surface of the rotation disk is peripherally provided with a first cam slot and a second cam slot respectively, the drive assembly comprises a first drive rod and a second drive rod enabling the first blade set and the second blade set to oscillate in response to directional drive of the first cam slot and the second cam slot, the respective ends of the first drive rod and the second drive rod are slidably engaged with the first cam slot and the second cam slot respectively, and the respective other ends of the first drive rod and the second drive rod extend in the X direction towards the air output region, and are connected to the first blade set and the second blade set respectively.
2. The air output device for an automobile air conditioner according to clause 2, wherein the rotation assembly comprises a first rotation disk having the first cam slot and a second rotation disk having the second cam slot, the first rotation disk and the second rotation disk are fixedly connected to each other by means of a connecting member, and the first cam slot and the second cam slot are respectively provided between surfaces of the first rotation disk and the second rotation disk facing each other.
3. The air output device for an automobile air conditioner according to clause 1, wherein the first drive rod and the second drive rod are adjacent to each other, one of the first drive rod and the second drive rod being provided with a guide slot along a straight line, the other being provided with a guide block extending into the guide slot, and engagement between the guide block and the guide slot enabling the first drive rod and the second drive rod to guide each other.
4. The air output device for an automobile air conditioner according to clause 1, wherein a plurality of first airflow guide blades are provided, and the first blade set further comprises a first connecting rod for linking the plurality of first airflow guide blades, a plurality of second airflow guide blades are provided, and the second blade set further comprises a second connecting rod for linking the plurality of second airflow guide blades, one end of the first drive rod is provided with a first drive block engaging with the first cam slot, the other end of the first drive rod is drivingly connected to one of the first airflow guide blades, and the first drive rod is parallel with the first connecting rod, and one end of the second drive rod is provided with a second drive block engaging with the second cam slot, the other end of the second drive rod is drivingly connected to one of the second airflow guide blades, and the second drive rod is parallel with the second connecting rod.
5. The air output device for an automobile air conditioner according to clause 4, wherein the first cam slot has, in sequence, a first concentrated air output point, a first rightward air output point, a first leftward air output point, and a first diffused air output point, and the second cam slot has, in sequence, a second concentrated air output point, a second rightward air output point, a second leftward air output point, and a second diffused air output point, wherein the rotation assembly, when moving, drives the first drive block to sequentially pass through the first concentrated air output point, the first rightward air output point, the first leftward air output point, and the first diffused air output point, while driving the second drive block to sequentially pass through the second concentrated air output point, the second rightward air output point, the second leftward air output point, and the second diffused air output point, so that directional movement of the first drive rod and the second drive rod directionally drives the first airflow guide blades and the second airflow guide blades to oscillate.
6. The air output device for an automobile air conditioner according to clause 5, wherein when the first drive block is at the first concentrated air output point, the second drive block is at the second concentrated air output point, and in this case, the first drive rod drives the first airflow guide blades to tilt towards the second airflow guide blades, and the second drive rod drives the second airflow guide blades to tilt towards the first airflow guide blades; when the first drive block is at the first rightward air output point, the second drive block is at the second rightward air output point, and in this case, the first drive rod drives the first airflow guide blades to tilt to the right in a first direction, and the second drive rod drives the second airflow guide blades to tilt to the right in the first direction; when the first drive block is at the first leftward air output point, the second drive block is at the second leftward air output point, and in this case, the first drive rod drives the first airflow guide blades to tilt to the left in the first direction, and the second drive rod drives the second airflow guide blades to tilt to the left in the first direction; when the first drive block is at the first diffused air output point, the second drive block is at the second diffused air output point, and in this case, the first drive rod drives the first airflow guide blades to tilt away from the second airflow guide blades, and the second drive rod drives the second airflow guide blades to tilt towards a position diffusing the first airflow guide blades.
7. The air output device for an automobile air conditioner according to clause 5, wherein the rotation disk moves by rotating, the first cam slot is ring-shaped as a whole, the first concentrated air output point, the first rightward air output point, the first leftward air output point, and the first diffused air output point are annularly arranged, the second cam slot is ring-shaped as a whole, and the second concentrated air output point, the second rightward air output point, the second leftward air output point, and the second diffused air output point are annularly arranged.
8. The air output device for an automobile air conditioner according to clause 7, wherein distances from the first concentrated air output point, the first rightward air output point, the first leftward air output point, and the first diffused air output point to the center of rotation of the rotation assembly are respectively L1, L2, L3, and L4, where L2=L4>L1=L3; distances from the second concentrated air output point, the second rightward air output point, the second leftward air output point, and the second diffused air output point to the center of rotation of the rotation assembly are respectively S11.1, S11.2, S11.3, and S11.4, where S11.1=S11.2>S11.3=S11.4.
9. The air output device for an automobile air conditioner according to clause 1, further comprising an electric actuator, wherein the actuator is drivingly connected to the rotation assembly so as to drive the rotation assembly to perform circular rotation.
10. An air outlet blade adjustment mechanism, characterized by comprising:
   a first blade set, comprising a plurality of airflow guide blades arranged at intervals in a first direction and rotatably provided in an air outlet;
   a second blade set, comprising a plurality of airflow guide blades arranged at intervals in the first direction and rotatably provided in the air outlet;
   a first shift fork, configured to move only in the first direction, connected to one of the airflow guide blades in the first blade set, and used to move to drive the airflow guide blades in the first blade set to rotate;
   a second shift fork, configured to move only in the first direction, connected to one of the airflow guide blades in the second blade set, and used to move to drive the airflow guide blades in the second blade set to rotate;
   a first drive member, connected to the first shift fork, and used to rotate to drive the first shift fork to be displaced in the first direction;
   a second drive member, connected to the second shift fork, and used to rotate to drive the second shift fork to be displaced in the first direction; and
   a power device, comprising a drive shaft, and used to drive, by means of the drive shaft, the first drive member and the second drive member to rotate synchronously, a rotation angle of the drive shaft comprising a plurality of consecutive rotation angle intervals, and displacement amounts and/or displacement directions of the first shift fork and the second shift fork being different in at least one of the rotation angle intervals.
11. The air outlet blade adjustment mechanism according to clause 10, wherein the first drive member is provided with a first mounting surface parallel with the first direction, the first mounting surface being provided with a first track slot portion, and the first shift fork being provided with a first connecting portion movable in the first track slot portion, wherein when the first drive member rotates, a side wall of the first track slot portion pushes the first connecting portion so that the first shift fork moves in the first direction;
   the second drive member is provided with a second mounting surface parallel with the first mounting surface, the second mounting surface being provided with a second track slot portion, and the second shift fork being provided with a second connecting portion movable in the second track slot portion, wherein when the second drive member rotates, a side wall of the second track slot portion pushes the second connecting portion so that the second shift fork moves in the first direction;
   extension tracks of the first track slot portion and the second track slot portion are different.
12. The air outlet blade adjustment mechanism according to clause 11, wherein transit axes of the first drive member and the second drive member coincide with the axis of the drive shaft of the power device.
13. The air outlet blade adjustment mechanism according to clause 12, wherein a first position-limiting portion is fixed on the first drive member, and a second position-limiting portion is fixed on the second drive member, the first position-limiting portion and the second position-limiting portion being sleeved on each other, and position-limited circumferentially.
14. The air outlet blade adjustment mechanism according to clause 10, wherein a bump is fixed on the first shift fork, and is provided with a chute extending in the first direction, and a slider having a shape matching a shape of the chute is fixed on the second shift fork, and is slidable in the chute.
15. The air outlet blade adjustment mechanism according to clause 10, wherein the first shift fork is provided with a first notch, and one of the airflow guide blades in the first blade set has a drive rod portion extending into the first notch, wherein when the first shift fork drives, by means of the drive rod portion and the first notch, the airflow guide blade to rotate, the drive rod portion slides relatively in the first notch in the depth direction of the first notch; the second shift fork is provided with a second notch, and one of the airflow guide blades in the second blade set has a drive rod portion extending into the second notch, wherein when the second shift fork drives, by means of the drive rod portion and the second notch, the airflow guide blade to rotate, the drive rod portion slides relatively in the second notch in the depth direction of the second notch.
16

The air outlet blade adjustment mechanism according to clause 15, wherein all of the airflow guide blades in the first blade set are transmissively connected by means of a first connecting rod so as to rotate synchronously, and all of the airflow guide blades in the second blade set are transmissively connected by means of a second connecting rod so as to rotate synchronously.
17. An electric air outlet assembly, characterized by comprising the air outlet blade adjustment mechanism according to any one of clauses 10-16.
18. A vehicle, characterized by comprising the electric air outlet assembly according to clause 17.

1. A vent assembly for a vehicle cabin, comprising:
a first set of vanes and a second set of vanes, each for directing air into the vehicle cabin;
a first cam path and a second cam path defined by one or more cams, the first and second cam paths being tracks defining a continuous loop on one or more planar surfaces of the one or more cams, the one or more cams being mounted to a common rotatable shaft, said planar surfaces perpendicular to a rotation axis of the common shaft;
a first cam follower operably coupled between the first cam path and the first set of vanes, and a second cam follower operably coupled between the second cam path and the second set of vanes, the first cam follower and the second cam follower each comprising a respective pin for engagement in the first cam path and the second cam path respectively, wherein
the first cam follower is coupled, at a position generally distal from its respective pin, to the first set of vanes;
the second cam follower is coupled, at a position generally distal from its respective pin, to the second set of vanes;
the first cam follower is constrained to move only along a longitudinal axis thereof and the second cam follower is constrained to move only along a longitudinal axis thereof, the respective longitudinal axes constituting an action-direction of the first and second cam followers such that a permitted movement direction of the first cam follower and a permitted movement direction of the second cam follower are parallel; and
rotation of the common shaft causes the one or more cams to rotate, and the first and second cam followers to follow the respective first and second cam paths, to adjust a relative angle of the first and second sets of vanes; and wherein
the first and second sets of vanes disposed side by side with the first set of vanes being disposed to the right of the second set of vanes, and the first and second cam paths are defined such that the first set of vanes and the second set of vanes can be configured in each of:
a first, neutral, configuration, in which both sets of vanes are aligned in the same, forward, direction,
a second configuration in which both sets of vanes are aligned in the same, leftward, direction,
a third configuration in which both sets of vanes are aligned in the same, rightward, direction,
a fourth configuration in which the first set of vanes is aligned in a leftward direction and the second set of vanes is aligned in a rightward direction so as to converge and concentrate airflow exiting the vent assembly, and
a fifth configuration in which the first set of vanes is aligned in a rightward direction and the second set of vanes are aligned in a leftward direction to diverge airflow into separate streams.

2. The vent assembly of claim 1, wherein the first cam path and second cam path are each defined on a respective cam wheel, the cam wheels both being fixedly mounted to the common shaft, to rotate with the common shaft.

3. (canceled)

4. The vent assembly of claim 2, wherein the first and second cam paths are on facing surfaces of the cam wheels, and wherein at least part of the first cam follower and the second cam follower are in slideable contact with each other between the cam wheels to retain the respective pins in the tracks.

5-6. (canceled)

7. The vent assembly of claim 1, comprising a motor for rotating the common shaft and a controller, for controlling the position of the first and second sets of vanes by controlling the motor to adjust the rotational position of the common shaft.

8. (canceled)

9. The vent assembly of claim 1, wherein within a complete rotation of the rotatable shaft the first, neutral, configuration arises twice and wherein from a first one of the first, neutral, configurations, rotation of the rotatable shaft in a first direction moves the vanes into the second configuration and rotation of the rotatable shaft in a second direction moves the vanes into the third configuration.

10. The vent assembly of claim 9, wherein from a second one of the first, neutral, configurations, rotation of the rotatable shaft in one direction moves the vanes into the fourth configuration and rotation of the rotatable shaft in an opposite direction moves the vanes into the fifth configuration.

11. The vent assembly of claim 1, wherein the first path has rotational symmetry of order 2 about its axis of rotation and has two axes of mirror symmetry, and the second path has no rotational symmetry and one axis of mirror symmetry.

12. The vent assembly of claim 11, wherein the first path comprises two lobes of substantially equal size at opposite sides of the rotational axes of the common shaft defining four first path positions comprising two first path minimal positions close to the axis of rotation and offset with respect to each other by 180 degrees along one axis of mirror symmetry of the first cam path, and two first path maximal positions remote from the shaft and offset with respect to each other by 180 degrees and offset from the minimal positions by approximately 90 degrees; and wherein the second path comprises a larger lobe on one side of the shaft and extending over a maximal range remote from the shaft at rotational positions corresponding with an approximately 90 degree rotation of the common shaft, and a smaller lobe on the other side of the shaft and extending over a minimal range close to the shaft at rotational positions corresponding with an approximately 90 degree rotation of the common shaft and wherein the axis of mirror symmetry of the second cam path is offset by approximately 45 degrees from said one axis.

13. A method of controlling the vent assembly as claimed in claim 1, the method comprising:
determining a current vane configuration of the first and second set of vanes,
selecting a desired vane configuration,
determining a smaller angle of rotation of the common shaft required to configure the first and second set of vanes in the desired configuration; and
controlling rotation of the common shaft through said smaller angle.

14. A vehicle comprising the vent assembly of claim 1, the vent assembly being disposed in the vehicle cabin directly in front of a front seat of the vehicle.

15. The vehicle of claim 14, wherein the vent assembly is disposed so that said fourth configuration directs the concentrated air flow through the steering wheel towards the driver.

16. The vehicle of claim 14 wherein the vent assembly is disposed directly behind a steering wheel of the vehicle.
